(19) United States
(12) Patent Application Publication
(10) Pub. No.: US 2007/0033112 A1
(43) Pub. Date: Feb. 8, 2007

(54) Internet textbook exchange

(76) Inventors: Patrick B. Nagle JR., Parkton, MD (US); Will DeSantis, Parkton, MD (US)

Correspondence Address: OBER / KALER;c/o Royal W. Craig, 120 East Baltimore Street, Baltimore, MD, 21202, US

(21) Appl. No.: 11/325,227

(22) Filed: Jan. 4, 2006

Related U.S. Application Data
(60) Provisional application No. 60/641,181, filed on Jan. 4, 2005.

(51) Int. Cl. G06Q 30/00

(52) U.S. Cl. 705/26

(57) ABSTRACT

An online ASP-managed system for web-based peer-to-peer book exchanges and, particularly, used text book exchange transactions. The system employs a software method by which a plurality of users subscribe, and it maintains a trade point account “checkbook” for each subscribed user. Multiple users enter a textbook ISBN number of one or more books that they need, and multiple users enter information regarding one or more books that they have to exchange (the latter including ISBN number and condition). The system assigns an equivalent trade point value (TPV) to each of the books available for exchange, the TPV being calculated as a predetermined fraction of an existing retail price factored in accordance with the condition of the book, and by a relative supply versus demand for said book. The system compares the ISBN numbers of books needed with books available for exchange and facilitates an exchange transaction provided that the user that needs the book has a positive trade point balance. The use of trade credits balances supply and demand.

### CROSS-REFERENCE TO RELATED APPLICATIONS

The present application derives priority from U.S. Provisional Application Ser. No. 60/641,181 filed Jan. 4, 2005.

### BACKGROUND OF THE INVENTION

1. Field of the Invention

The present invention relates to Internet exchange platforms and, more specifically, to an Internet-based system for providing end users with the ability to exchange used books, particularly textbooks, and other used goods, using an online crediting system in which a credit value is calculated and assigned for each book based on retail value, book condition and supply and demand, the exchange incentives therein balancing supply and demand.

2. Description of the Background

The Internet has evolved as an excellent medium of exchange, and a variety of exchange platforms available over the Internet have become well known in the art. Many of these systems operate by on-line auction, or by individual “post-and-match.” In both cases, a prospective buyer bids on an item, and if the bid wins the auction or matches the seller's selling price, the item is sold. One example of the auction format is Ebay, and their affiliate Half.com is an example of post-and-match. While these formats work well for certain products, they typically do not for others. One item in the latter category is textbooks. There is a huge market for textbooks, but the market is fragmented because there are so many different texts. Moreover, demand for textbooks is sporadic: driven by course schedules and school calendars. No single used-textbook clearinghouse has emerged, and so the Supply of used textbooks has difficulty keeping up with demand. Students can't count on getting the used books they need when they need them. Instead, they must turn to new books. Consequently, publishers presently dominate the supply chain. By virtue of their exclusive licensing deals with authors, publishers are able to extract a premium from students. Indeed, many feel that textbook prices have gotten out-of-hand, with some costing upwards of $300. These are books that will only be used for about four to five months. Moreover, publishers are continually issuing new editions to make used books obsolete. All this is occurring in the face of rising tuition costs when students are looking for ways to save money.

Currently, there are no peer-to-peer exchanges for used textbooks because the value of a used text is based on subjective factors such as age, version or condition, and no one has proposed a system to balance supply with demand in the face for non-uniform goods like used textbooks. There remains a significant demand for an efficient platform for exchanging used textbooks, and to facilitate, foster and encourage such transactions while at the same time balancing supply and demand.

### SUMMARY OF THE INVENTION

It is therefore an object of the present invention to provide an application service provider (ASP) managed peer-to-peer exchange for used books, textbooks, and other goods, to facilitate, foster and encourage such transactions while at the same time balancing supply and demand.

It is another object to using a peer-to-peer exchange for used text books in which a credit value is calculated and assigned for each book based on retail value, book condition and supply and demand.

In accordance with the foregoing object, the present invention is an ASP-managed system for web-based peer-to-peer book exchanges and, particularly, used text book exchange transactions. The system employs a software method comprising the steps of, subscribing a plurality of users and maintaining a trade point account “checkbook” for each subscribed user.

Multiple users enter a textbook ISBN number of one or more books that they need, and multiple users enter information regarding one or more books that they have to exchange (the latter including ISBN number and condition). Each book is logged in a database along with the textbook ISBN numbers and other entered information.

The system assigns an equivalent trade point value (TPV) to each of the books available for exchange, the TPV being calculated as a predetermined fraction (e.g., 80%) of an existing retail price of said books factored in accordance with the entered condition of the book, and further factored by a relative supply versus demand for said book.

The system compares the ISBN numbers of books needed with books available for exchange, and when a match is found it notifies the user that needs the book that a requested book is available for exchange.

The user that needs the book is presented with a graphical user interface that facilitates an exchange transaction with the user that has the book for exchange. The system automatically determines whether the trade point account for the user that needs the book reflects a positive trade point balance sufficient to complete the exchange transaction. If so, the system binds an agreement between the two users to complete said exchange transaction.

The user that wishes to exchange the book is required to ship the book, and a graphical user interface to enter tracking information. When the book is shipped, that user's account is credited by the TPV of the book, and the recipient's account is debited by the TPV of the book.

The use of trade credits balances supply and demand, and an ASP administrator interface is provided to facilitate effortless exchange transactions. The system allows students to trade all the textbooks they need for one low subscription fee per year, and in the face of rising tuition costs allows them to save hundreds of dollar each semester over new text book costs.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a diagram of the system architecture.

FIG. 2 is a basic flow chart of the method.

FIG. 3 is a screen print of the website homepage

FIG. 4 illustrates the member sign in page.

FIG. 5 is the ‘LOGIN’ page.

FIG. 6 is a screen print of a My Account page.

FIG. 7 is a screen print of the Search TextBooks Page.

FIG. 8 is a screen print of the ‘My Inventory’ page.

FIG. 9 is a screen print of the ‘Trade Point Value (TPV) Calculation’ page.

FIG. 10 is a screenshot of the My Requests' Section.

FIG. 11 is a screen print of the My Messages' screen.

FIG. 12 is a screen print of the ‘Printable Flyer’ sub-section.

FIG. 13 is a screen print of the ‘Hotlink’ section.

FIG. 14 is a screen print of the ‘Update Profile’ section.

FIG. 15 is a screen print of the ‘Book Details Page.

FIG. 16 is a screen print of the ‘Member Rating’ details page.

FIG. 17 is a screen print of the My Transactions page.

FIG. 18 is a screen print of the ‘Accept Request’ details page.

FIG. 19 is a screen print of the ‘Confirm Book Receipt Details’ page.

FIG. 20 (Reserved)

FIG. 21 is a screen print of the ‘Trading Transactions’ sub-section.

FIG. 22 is a screen print of the ‘Administrative Module Homepage’.

FIG. 23 is a screen print of the ‘Membership Management Utility’ main page.

FIG. 24 is a screen print of the complete member details.

FIG. 25 is a screen shot of the ‘Checkbook’ details page of a member

FIG. 26 is a screen print of the ‘Adjust Trade Checkbook’ details page

FIG. 27 is a screen print of the ‘Finances Checkbook of a member.

FIG. 28 is a screen print of the ‘Discount Management Utility’ main page.

FIG. 29 is a screen print of the ‘Add New Discount’ form page

FIG. 30 is a screen print of the ‘Message Management Utility’.

FIG. 31 is a screen print of the ‘Banner Management Utility’ main page.

FIG. 32 is a screen print of the ‘Administrator Rights Utility’ main page.

FIG. 33 (Reserved)

FIG. 34 is a screenshot of the Unavailable book requests page.

### DETAILED DESCRIPTION OF THE PREFERRED EMBODIMENTS

The present invention is an Internet-based system for providing end users (students) with the ability to exchange textbooks using an online crediting system in which a credit value is calculated and assigned for each textbook, and the distribution of these credits balances supply and demand.

The system is implemented on a secure web-enabled server facility including at least one general purpose web server. The software is herein described in its preferred embodiment, which is adapted for distribution by an application service provider (ASP) accessible by subscribers (the software being resident on the web server). One skilled in the art, however, will readily understand that the software method of the present invention can alternatively be distributed as shrink-wrap peer-to-peer software or client-server software.

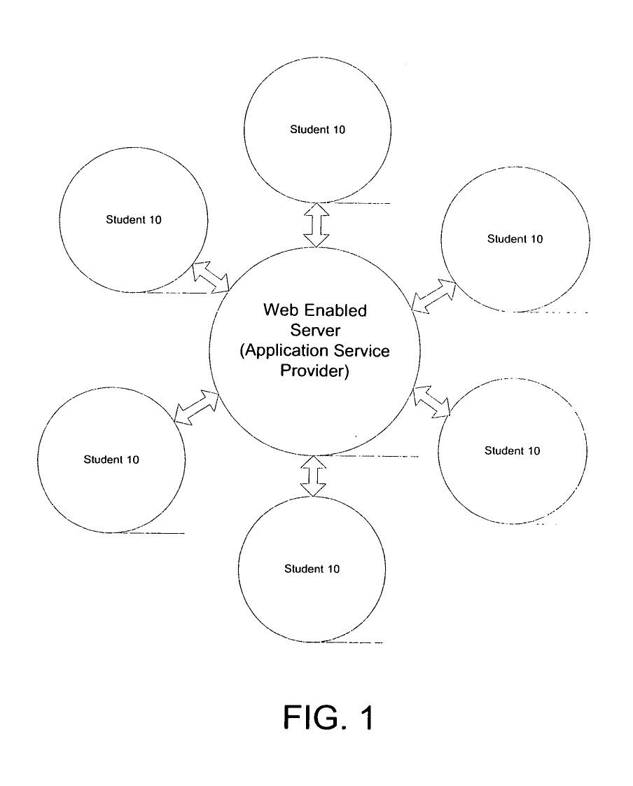

FIG. 1 is a diagram of the system architecture, which includes a conventional web-enabled server facility (shown at center) with web-enabled communications and network configuration, including network security, maintained by an application service provider (ASP) to provide a web portal for multiple users to access. Secure client communications are accomplished via priority security technology, such as Cisco, and include a VPN, firewalls and encryption.

Users interface with the web portal via their own Web browser. All users start their session by initiating their web-browser software, connecting to the Internet and the appropriate URL to access the resident software according to the invention. Minimum user requirements are a standard PC computer with a Pentium® or equivalent processor and 128 MB RAM, Windows® operating system, Internet Explorer® 4.0 or other browser, and a dial-up or broadband connection.

A. Method Overview

The present method allows students to trade all the textbooks they need for one low subscription fee per year, by maintaining a balanced market system based on trade credits. For each student, all surplus textbooks may be sold for positive trade credit, and desired textbooks can be bought by spending trade credit. This is accomplished with a multi-peer trading platform that instills security, efficiency and uniformity into each transaction, which promotes a balance between supply and demand to maintain the market. Each subscribing student user is assigned a virtual checkbook for their account. Every time they sell a textbook their checkbook is credited with a positive trade credit for the calculated value of their book, and vice versa for a purchase. These checkbooks can be used for transactions with any other subscriber, thereby allowing multi-tier trading which enhances success by 99.9% in locating used textbooks that are needed, and in offering used textbooks for sale. The system distinguishes itself in the mechanics of the method and, particularly, the software which allows students to search, trade, and receive textbooks, with completion of each transaction assured in a most efficient and secure manner. Moreover, the online crediting system promotes a balance between supply and demand. It has been calculated that the average current savings a student can realize through the present system is approximately $362.00 per semester.

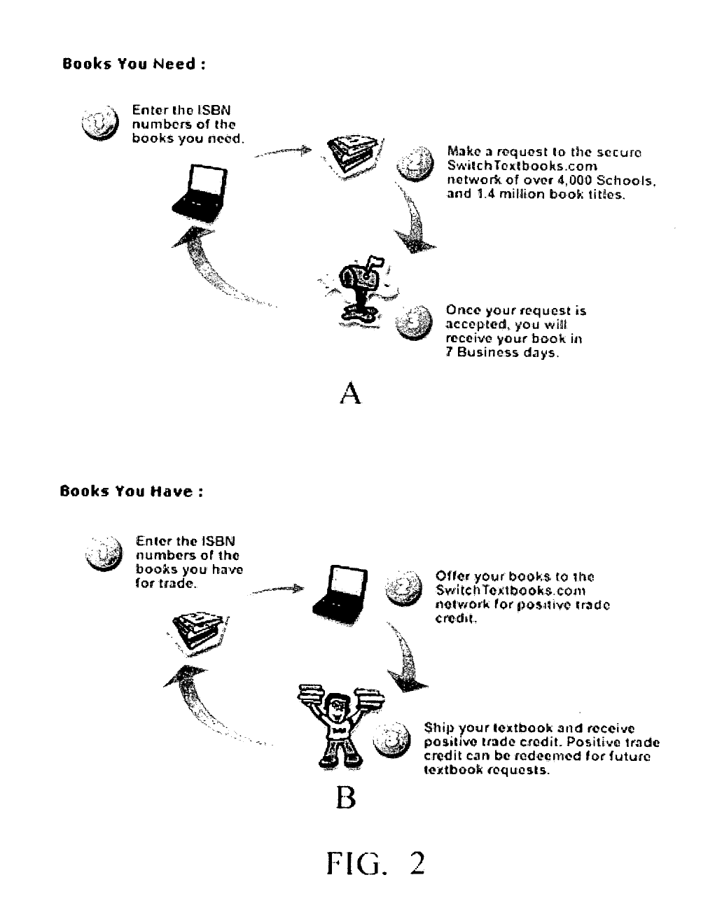

FIG. 2 is a basic flow chart of the method, which illustrates at A) the purchase transaction, and at B) the sale. To purchase (as shown at A), the student enters the textbook ISBN numbers of one or more books that they need. The system automatically searches a network of over 4,000 Schools and 1.4 million book titles. Once a request is accepted, the student receives the textbook(s) within seven business days and their checkbook is debited. To balance purchase requests, the system actively promotes an equal number of sales by the same student. In order to sell (as shown at B), the student enters the ISBN numbers of the surplus books they have available. The list is entered into the library, searches by others are queued toward the entries, and when another student chooses the sellers books the transaction is completed for trade credit. Typically books ship within 3-5 business days. Online tracking is provided so users can view requested textbooks in transit.

To maintain an even system-wide trade balance, the system employs “trade points.” Every time a user ships a textbook their checkbook is credited positively for the point value of the book shipped. Every time a student receives a textbook their checkbook is debited for the point of the book received. To establish a balance, members are able to purchase and receive textbooks when they have a positive checkbook balance, and are forced to ship textbooks with insufficient checkbook funds. Uniformity of pricing is established by a set pricing formula. Textbooks are assigned point values based on three factors: Retail Value, Book Condition, and Supply and Demand. Through a particular point value calculation, all books traded are measured by their true value.

The benefits of the present system include significant time and money saving each semester, virtual assurance that a student will be able to get all the textbooks they need, the ability to easily reclaim the investment by trading used textbooks, a secure online trading network and others.

The present system accomplishes the foregoing with a web-implemented software solution comprising two modules: 1) A Front End Subscriber Module for allowing students to subscribe to the present system, for allowing them to post and exchange textbooks, and to facilitate the exchange; and 2) a Management Module t-or allowing “Administrators” to implement and manage the present system, and to provide account management, reports and performance tracking.

The two modules are constructed atop a foundation comprising a relational database design, each module including a simple series of graphical user interfaces that allow direct data entry. Both Modules are described in more detail below.

B. Subscriber Module

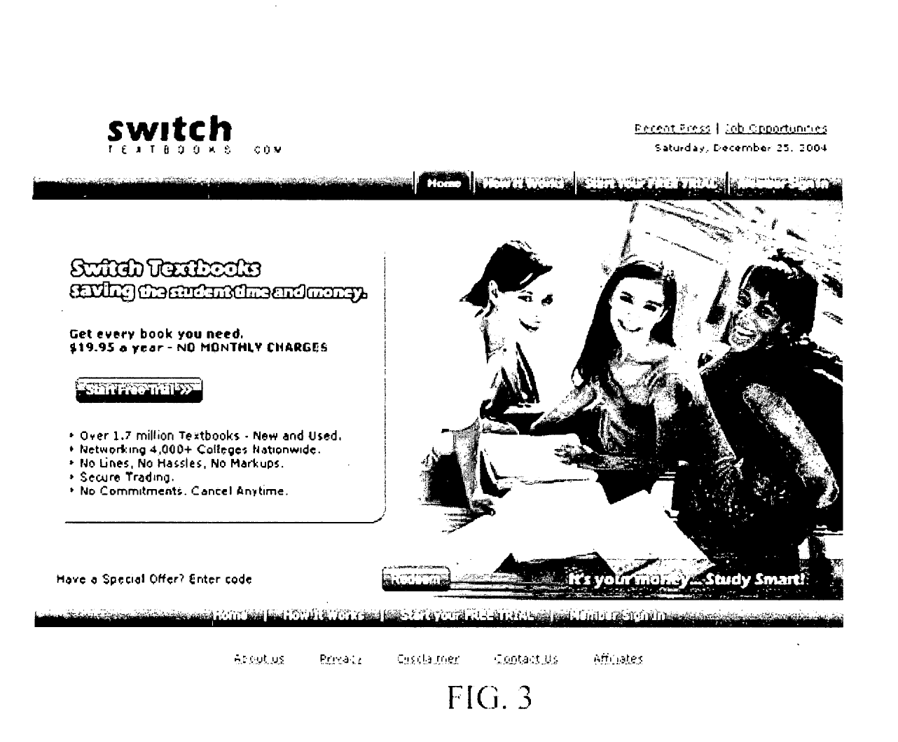

The subscriber module is accessible by URL (www.switchtextbooks.com) and initially displays a website homepage as shown in FIG. 3. The various elements on the website homepage are as follows:

Top Navigation Bar: includes the main navigation links which remain common throughout the website. The navigation link where the user is currently is highlighted. The top navigation links are detailed as follows:

Home (default): Click on this top navigation link to go to the homepage of the website at any point of time. When the user is in the homepage this link is highlighted and disabled.

How it Works: Click on this link to go to the ‘How It Works’ main page. The ‘How it Works’ page is an explanatory page with ‘How It Works’ Content framed in Frequently-Asked-Question (FAQ) format, inclusive of a right navigation column, which displays a list of all the FAQ's (Frequently Asked Questions). Each question in the FAQ list is a hyperlink. The user can click on the appropriate FAQ question link on the right column & the appropriate answer description is presented in the main content area. The default question in the FAQ list is ‘How it Works’. Thus when the user comes to this section, the ‘How It Works’ description is displayed in the main content area by default. The content in this section is presented in form of graphical images along with textual descriptions.

Start your Free Trial: Clicking on this link takes the user to a ‘Free Trial Registration’ form page.

My Account: clicking on this link takes a subscriber to their account information.

Logout: logout.

Main Content Area: The middle portion of the website homepage is reserved for main content: textual as well as graphical content.

Redeem (Have a Special Offer? Enter Code): If the user has received any discount code from any other registered user of the ASP who referred him to this website or any promotional code directly from The ASP, then he can enter the code in the textbox provided and click on the Redeem button. The discount/promotional code functionality details will be described later. Footer Links are provided at the bottom in a homepage footer, including the following elements: HTML links for top navigation buttons (Repeated)

Static Content Page links: The footer area will also consist of links to all the static content pages of the website. These links are common throughout the website. The user is taken to the appropriate static HTML page by clicking on the corresponding link from the footer. The various static content page links are as follows:

About Us: Click on this link to go to the static ‘About Us’ content page. This page has company and management related content about The ASP.

Privacy: Click on this link to go to the static content page, which defines the privacy policy of the ASP.

Disclaimer: Click on this link to go to the static content page, which defines the disclaimer policy of The ASP.

Contact Us: Click on this link to go to the static content page containing the contact information of The ASP.

Copyright Notice: The bottom of the homepage will display the static copyright notice. This is common throughout the website.

Typically, a visitor will begin by starting a free trial. On clicking the ‘Start Your Free Trial’ link from the top navigation, the user is taken to the ‘Free Trial Registration’ form page. The free trial registration is a 2-step process. The first step of free trial registration captures the personal details of the user who is registering. This requires completion of a sign-in form similar to full registration. Table 1 below illustrates the Personal Details required for registration.

TABLE 1
Personal Details (Step-1 Registration Form) Fields

| # | Field Name | Type/Size | Description | Validation Rules |
|---|---|---|---|---|
| 1. | Last Name | Text/50 | Last name of the | Mandatory (not null) |
| | | | member | |
| 2. | First Name | Text/50 | First name of the | Mandatory (not null) |
| | | | member | |
| 3. | Gender | Dropdown | Select the gender from | Mandatory (not null) |
| | | list box | dropdown list i.e. Male | |
| | | containing 2 | or Female | |
| | | options — | | |
| | | Male & | | |
| | | Female | | |
| 4. | Email ID | Alphanumeric/ | Email address of the | Mandatory (not null) |
| | | 50 | member. This is the | The email address is |
| | | | usemame of the | UNIQUE in the member |
| | | | member during login. | DB i.e. NO two members |
| | | | | in the DB can have the |
| | | | | same username (email ID) |
| 5. | Enter | Encrypted/ | This password is | Mandatory (not null) |
| | Password | 20 | required by the | Minimum 6 characters |
| | | | member to log in | |
| 6. | Re-enter | Encrypted/ | Re-enter the same | Mandatory (not null) |
| | Password | 20 | password entered in | Exactly same to the |
| | | | last field | password filled-up in last |
| | | | | field |
| 7. | Date of Birth | Dropdown | Select date of birth | Mandatory (must select a |
| | | boxes for | | option from each drop- |
| | | date, month | | down) |
| | | & year | | |
| | | selection | | |
| 8. | Select State | Dropdown | Select state of location | Mandatory (must select a |
| | | list box | On selecting a state | state from drop-down) |
| | | containing | from the dropdown list, | |
| | | all US state | the page gets refreshed | |
| | | names | & a list of schools | |
| | | | belonging to that state | |
| | | | is shown in the next | |
| | | | dropdown field | |
| 9. | Select School | Dropdown | Select a school from | Out of the 2 fields i.e. |
| | | list box | the state specific school | ‘Select School’ & ‘Enter |
| | | containing a | list | school name if not |
| | | list of all the | If the appropriate | available in list’, one is |
| | | schools in | school is NOT | Mandatory |
| | | the selected | available in the list, | If the user selects a school |
| | | state (in last | then the next field i.e. | from this list then the next |
| | | field) | ‘Enter school name if | field automatically |
| | | | not available in list’ | becomes Optional |
| | | | becomes a mandatory | If the user can't find his |
| | | | field for the user | school in this list then the |
| | | | | next field automatically |
| | | | | becomes Mandatory |
| 10. | Enter School | Alphanumeric/ | Enter school name if | Optional, if school |
| | Name if Not | 100 | not selected in last field | selected in last field |
| | Available in | | | Mandatory, if school |
| | List | | | NOT selected in last |
| | | | | field |
| 11. | Degree | Alphanumeric/ | Enter name of degree | Optional |
| | | 50 | the student is pursuing | |
| 12. | Major | Alphanumeric/ | Enter the subject in | Optional |
| | | 50 | which the student is | |
| | | | doing his/her major | |
| 13. | Year In | Alphanumeric/ | Enter ‘year in school’ | Optional |
| | School | 15 | value. (auto changes to | |
| | | | Freshman Sophomore, | |
| | | | Junior, Senior, Grad | |
| | | | School) | |
| 14. | Address 1 | Alphanumeric/ | Enter shipping address 1 | Mandatory (not null) |
| | | 100 | A static note has to be | |
| | | | provided beside the | |
| | | | ‘Shipping Address’ | |
| | | | details section of the | |
| | | | form informing the | |
| | | | member that this is the | |
| | | | address where they will | |
| | | | receive books & hence | |
| | | | it should be entered | |
| | | | correctly. | |
| 15. | Address 2 | Alphanumeric/ | Enter shipping address 2 | Optional |
| | | 100 | | |
| 16. | City | Alphanumeric/ | Enter city of shipping | Mandatory (not null) |
| | | 50 | address | |
| 17. | State | Dropdown list | Select state of shipping | Mandatory (must select |
| | | box | address | a state from drop-down) |
| | | containing all | | |
| | | US state | | |
| | | names | | |
| 18. | Zip Code | Alphanumeric/ | Enter zip code of | Mandatory (not null) |
| | | 15 | shipping address | |
| 19. | Phone | Alphanumeric/ | Enter telephone | Optional |
| | | 15 | number | |

After filling up all the mandatory details, the user is able to proceed to the next step by clicking on the ‘Continue’ button. The system validates all the entered field values against the defined validation rules and provides appropriate error messages. The registrant has to rectify the errors to proceed forward. The registrant can also click on the ‘Cancel’ button to cancel the registration process or he/she can click on the ‘Reset’ button to reset the filled-up field values to blank forms. On successful submission of this form the member record is automatically added to the ‘Member Database’ as a record with ‘INACTIVE’ status i.e. the member will not be able to login as a ‘TRIAL’ member until & unless he completes the ‘Email Address Confirmation’ step to be described. Once a member record is added to the member database, the system automatically generates & assigns a unique 8 digit alphanumeric member code to the member record. This code is randomly generated by the system & will uniquely identify each member record.

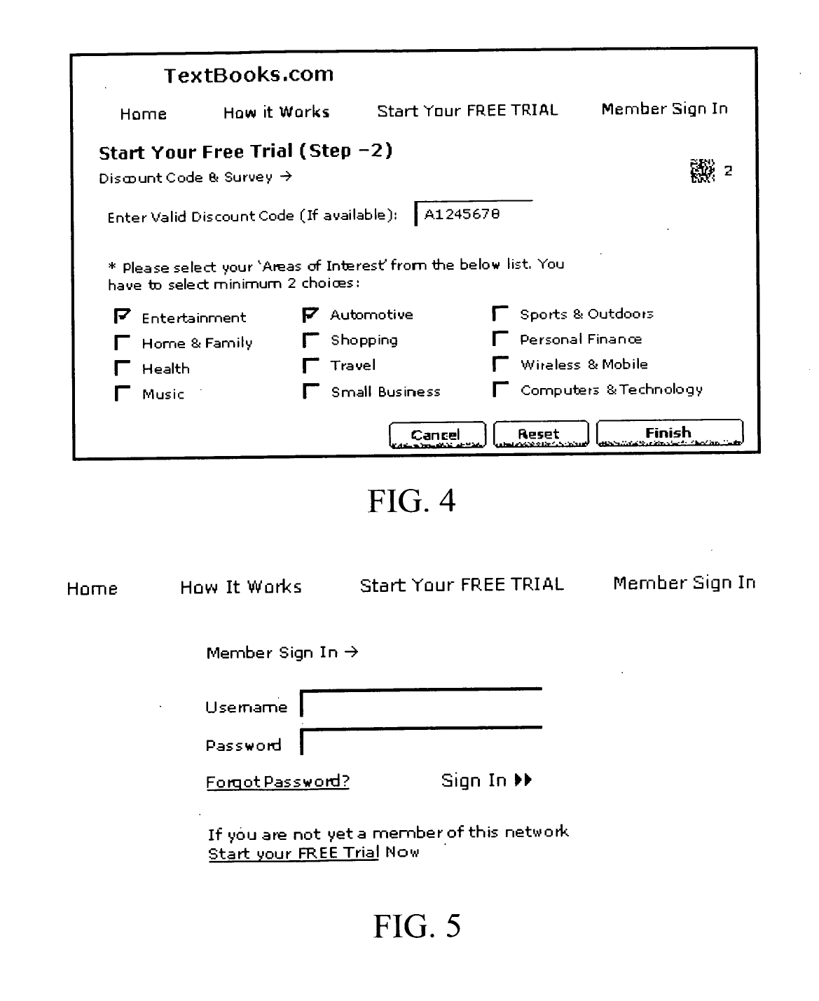

Next, as shown in FIG. 4, the registrant completes a second form by which he can enter a discount code if available and also select areas of interest (minimum 2). The system presently has 2 types of ‘Discount Codes’ including referral (Flyer Program) Discount Codes, and promotional discount codes generated by the Administrator via the ‘Admin Module’. Referral (Flyer Program) Discount Codes are the actual member codes of referring members which are used to gain discounts when a referred user subscribes. Promotional discount codes are generated by the Administrator, are unique, and never clash with any of the referral member codes.

The purpose of capturing the user's ‘Areas of Interest’ is for the reason that specific banner advertisements are mapped to these interest areas by the Administrator so that once this member logs in to his ‘Account Area’ the system will intelligently display him only his interest specific ad banners in the promotional area. This functionality is explained in greater details in the Admin module functionality requirements. The field descriptions along with validation rules is as per the following table:

| # | Field Name | Type/Size | Description | Validation Rules |
|---|---|---|---|---|
| 1. | Discount | Alphanumeric/8 | Enter ‘Discount | Optional |
| | Code | | Code’ if available. | If the registrant enters an 8-digit |
| | | | Refer discount code | discount code, then the system |
| | | | functionality | will validate the code. If |
| | | | explained below for | discount code is validated then |
| | | | further details. | appropriate points/dollars is |
| | | | | credited to the registrants |
| | | | | account. If discount code cannot |
| | | | | be validated then appropriate |
| | | | | message is displayed beside the |
| | | | | form field & he is allowed to |
| | | | | proceed with blank value in |
| | | | | discount code area |
| 2. | Areas of | Checkbox | All areas of interest | Mandatory (Minimum 2 |
| | Interest | options | options is displayed | options has to be selected) |
| | | | in the form. The | |
| | | | areas of interest | |
| | | | options is hard- | |
| | | | coded in the | |
| | | | application. The | |
| | | | registrant can select | |
| | | | the appropriate | |
| | | | areas of interest by | |
| | | | selecting the | |
| | | | associated | |
| | | | checkboxes | |

There are two sets of discount codes: referral and promotional. The referral code is typically the 8 DIGIT auto-generated code assigned to a member record. Any TRIAL or ACTIVE member can publish their own referral code to all their friends, who can then enter this as a referral code in step-2 of the registration. On validation of the code, the member who referred this registrant is ELIGIBLE to receive a $5 referral bonus & the registrant will receive +5 free ‘Trade Credit Points’ in their respective checkbooks. The referral bonus is awarded only if both parties are or become ‘ACTIVE’ members, while the +5 ‘Trade Credit Points are awarded to the checkbook immediately once he registers successfully. Promotional codes are those generated by the Administrator module for promotional purposes.

After filling up this step-2 form, the registrant can click on the ‘Finish’ button to complete the trial registration process. On clicking the ‘Finish’ button the system will validate all the entered field values against the defined validation rules (as explained in the table) and will provide appropriate error messages if any. On successful validation, the registrant is taken to the ‘Email Address Verification’ message page. In addition, an auto-generated email is automatically sent to the registrant's email address with a ‘Trial Account Activation’ link. This email contains a Email Address Verification Link. Once the registrant clicks on the ‘Email Verification Link’ in the email he received in his ‘Email Account’, his browser opens an ‘Email Validation Complete’ page which provides a validation confirmation message as well as a link to a ‘Member Sign In’ Page.

Once the member record is added to the ‘Member Database’, the system automatically generates a unique 8-digit Alphanumeric Member Code and will assign this code to the member record. This member code is unique for each member record in the database i.e. no two member records in the database can have the same member code. e.g. A1234567.

To bypass the trial registration, registered members can click on the Member Sign In link (top right) to go directly to the login page.

FIG. 4 illustrates the member sign in page. After successful login by the member, the navigation links ‘Start Your Free Trial’ and ‘Member Sign In’ are replaced with ‘My Account’ and ‘Logout’ on the home page.

There are three member categories: Trial, Active and Inactive. Once the member record is added to the member database after completion of the trial registration process, the member category assigned to this record is ‘Inactive’ and a mail is sent to the registrant's email address for email address validation. Once the registrant validates his email address by clicking the link on the email, the system will automatically update the member record status from ‘Inactive’ to ‘TRIAL’. ‘TRIAL’ members have access to all the sections of the ‘Member Account Area’ including search textbooks, update profile, requests, inventory, transactions, messages and account checkbook. They are eligible to receive +5 free ‘Trade Credit Points’ on registration, but are not eligible to receive a $5.00 ‘Referral Bonus’ for each user registered (and paid active member) via a referral discount code. Trial members can initiate buy and sell actions but cannot carry them through. For example, they can add textbooks into a ‘My Inventory’ folder for sale, or to a ‘My Requests’ folder for purchase. However, TRIAL members are not allowed to make an actual request to a book owner for receiving a book or to take part in a ‘Receive Book’ transaction until and unless he pays an annual membership fee. Thus, as soon as the trial member tries to send a request to the owner to receive any book found in the trading network, then the system directly takes him to the ‘Credit Card’ payment page for full registration. Once a trial member pays the annual membership fees the member is upgraded to the ‘ACTIVE’ member Category/status. Thus, registered ‘TRIAL’ members become ‘ACTIVE’ members by paying the annual membership fees. Without full sign-up, a ‘Trial’ member is/not be able to do the following activities in the trading network

TRIAL members are able to accept book requests for all textbooks in inventories, ship book and complete entire transaction as a book SENDER/Owner.

TRIAL members are not allowed to make a request to a book owner for receiving a book i.e. the trial member will not be allowed to take part in the ‘Receive Book’ transaction until and unless he pays the ‘Annual The ASP Membership Fees’

ACTIVE members have full membership rights, and can access all the sections of the ‘Member Account Area’ including search textbooks, update profile, requests, inventory, transactions, messages and account checkbook as will be described. Active members are eligable to receive a $5.00 ‘Referral Bonus’ for each user registered (and paid active member) via his referral discount code.

INACTIVE members are NOT allowed to log-in at all.

Member Log-in: any ‘TRIAL’ or ‘ACTIVE’ member can access his/her ‘Account Area’ by logging in using his ‘Username’ (Email Address) and ‘Password’, after clicking on the ‘MEMBER SIGN IN’ link available on the top navigation bar. The layout of the ‘LOGIN’ page is as shown in FIG. 5, and standard Login’ and ‘Forgot Password’ procedures are used. If the user is validated, he/she is directly given access to his ‘Account Area’. The member is allowed to login only if his member status in the ‘Member DB’ is either ‘Trial’ or ‘Active’.

Member Accounts

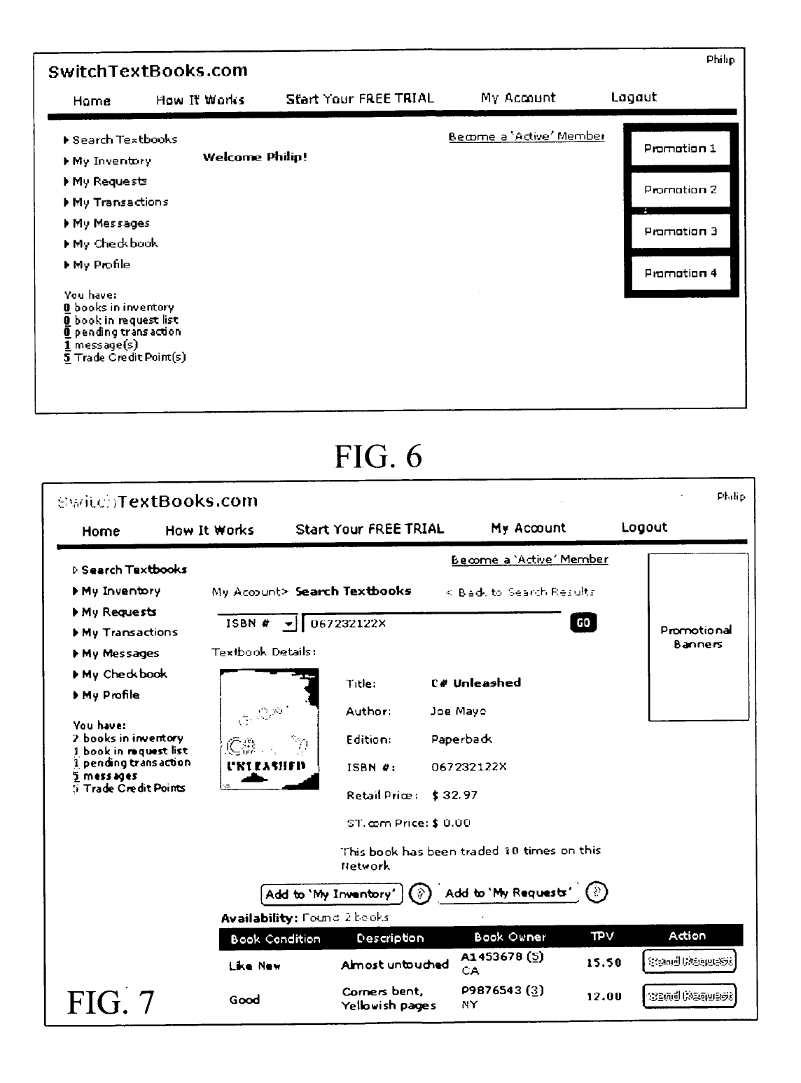

The member accounts and the peer-to-peer trading method implemented thereby form the heart of the current invention. On successful login, the member is given access to his personalized ‘My Account’ area main page. FIG. 6 is a screen print of a My Account page. In addition to the top menu bar, a left navigation bar is displayed which remains available when the member is inside his ‘My Account’ area. This left navigation bar has the following links:

A summary listing of various activities (bottom left) pertaining to a member's account like number of books he has in his inventory., if there are any un-read messages, number of trade credit points in his checkbook etc. This summary box provides latest updated information to the member about his account activities at any point of time, so that the member need not get into specific account sections every time to check out the latest details.

Promotional area (on the right), which will display a list of advertisement banners targeted to the areas of interest selected by this member during registration.

Top Navigation Menu (previously explained)

Account related links (shown at left, including 1) Search TextBooks; 2) My Inventory: 3) My Requests; 4) My Transactions; 5) My Messages; 6) My Profile). Each Account Related Link is explained below.

1. Search Textbooks

On clicking this link, the member is taken to a ‘Search Textbooks’ details page where the member can search for specific textbooks from a Books DataBase based on various search parameters. FIG. 7 is a screen print of the Search TextBooks Page. The member can search textbooks on the basis of the following parameters (or combinations thereof):

ISBN Number

Textbook Title

Author Name and

Keyword

The member can select any of the above search parameters from the dropdown list, enter the corresponding search string and click on the ‘Go’ button to search the textbook database. The search engine relies on a commercial textbook database, for example, the Baker and Taylor database, which is housed at the server. If the Searched Book is not found in Book Database the member is able to request the Administator to add that particular book in the database. The member can fill-out an add book request form and then click on the ‘Request to Add Book’ button to submit the request. The system will send an auto-email to the email address of the Administrator informing him about the request submitted by the member. The Administrator is able to view all the unavailable book requests in this utility and is able to send these requests to the database vendor (Baker and Taylor) as an email message. The request is also stored in a ‘Member Book Requests’ database at the back-end. This way, if this particular requested book is added to the book database and is also found available in the trading network (inventory) then an auto email is sent to the visitor informing him about the availability of the book he requested. Upon a successful search (searched book(s) FOUND in the Book database), the page gets refreshed and the search results are displayed below in the form of links. The search result links are also associated with a thumbnail image of the book(s) if available. In the ‘Search Results’ page, the member can click on the ‘Search Result’ link to go to the ‘Textbook Details’ page. The ‘Textbook details’ page will display the following details about the searched textbook from the Book Database.
ISBN Number of book
Textbook Jacket Cover Photograph (If no photo available standard ‘No Image available’ message)
Book Title
Author of the book
Book Edition i.e. Paperback or Hard Cover
Book Availability in the Network

If the book is NOT available in any member's inventory, then the following message is displayed in this area: ‘This book is currently NOT available in the Network!’ If the book is AVAILABLE in the network the converse is displayed.

Number of times this textbook has been traded on the network (This is a cooked up value ranging between 5-60).

In addition to the textbook details from the Book Database, this ‘Textbook Details’ page will also display the following details only if the logged in member is a trial member (not signed up yet), as an incentive to join: Price (set at $0.00 as a psychological factor for the visitor to sign-up).

In addition to the textbook details, the member will also find 2 more buttons in the ‘Textbook details’ page: Add to My Inventory; and Add to My Request (see descriptions below). The ‘Textbook details’ page also has a checkbox ‘Notify me when book is available’. If the member selects this checkbox, then the subsequent functionality is same as that of adding it to request list i.e. the member is notified immediately when this book becomes available in the network.

2. My Inventory

On clicking this link, the member is taken to the ‘My Inventory’ section of his account area. ‘My Inventory’ section will display a list of all the books, which this particular member has added in his personal inventory. A facility is also provided in this page for the member to add additional books in his inventory. When a member adds any book in his inventory list it means that this member possess this particular book and he is interested in trading this book with another member. This book inventory list of the member (as well as ‘Book Condition’) is taken into account by the system while calculating ‘Supply Demand Ratio’, ‘Trade Point Value’ of books and for matching book requests and availabilities.

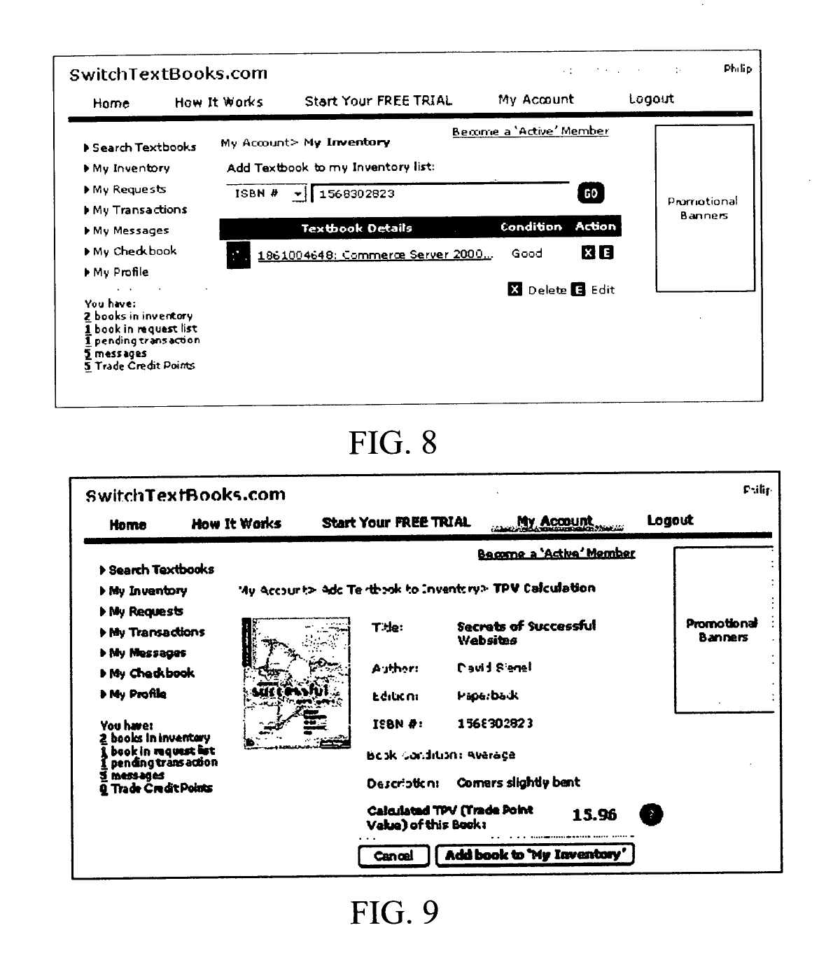

FIG. 8 is a screen print of the ‘My Inventory’ page. The ‘My Inventory’ page displays a book listing under TextBook Details, which means that this member had added this book to his inventory. Each existing book in the member's inventory list is associated with 2 action buttons:

Edit (to Edit the listed book): the member can utilize this functionality to edit specific books he listed earlier in his inventory list. Editing will only pertain to modifying the condition of the book he earlier specified (thus changing the trade point value “TPV” of the book—explained later).

Delete: The member can click on this action link associated with each book record in the list to delete that particular book from his inventory list. As mentioned previously, the member is able to add a book to his inventory via the ‘Add book to my Inventory list’ box on the top of the page. Alternatively, after search, once the member comes to the ‘Book details’ page he can click on the ‘Add to Inventory’ button to add the searched book into his ‘Inventory’ list. On clicking the ‘Add to Inventory’ button from the ‘Book Details’ page, the member is taken to the ‘Define Book Condition’ page. A member cannot have 2 books with the same ISBN # in his ‘My Inventory’ list. In the above ‘Book Condition’ window, the member has to describe the condition of the book he possesses. Select the appropriate textbook condition from the dropdown list. There is a “?” button next to the dropdown list, by clicking which a small window will pop-up describing each book condition in the list. The options to be a available in the dropdown list box are:

Like New

Good

Average

Below Average

Poor

In addition, the user enters ‘Description’ of the book in the text box provided (corners bent, yellowish pages etc). After selecting and entering the book condition details, the member can submit the information by clicking on the ‘Submit’ button. On clicking the submit button, the member is taken to the ‘Trade Point Value (TPV) Calculation’ page. The screen layout of this page is as shown in FIG. 9. In the ‘TPV Calculation’ page, the equivalent ‘Trade Points Value’ of the book being added by the member is calculated and displayed. The TPV value of the book is automatically calculated and generated by the system based on three factors: Retail Price of the book. Condition of the book, Demand-Supply ratio of the book. Specifically, the Trade Points Value Calculation for Textbooks (TPV) is automatically calculated and generated by the system based on the following factors:

Retail Price of the book as per Baker and Taylor Database

Condition of the book specified by the member and

Demand-Supply ratio of the book determined by the system as per the last updated network data.

More specifically, the Calculation Process includes four steps as follows:

a) STEP-1: Conversion of Book Retail Price to Equivalent Trade Points. The Retail Price of the book can be converted to equivalent ‘Trade Point Value’ basis of the following formula: Equivalent Trade Point Value of New Book=Retail Price of New Book*0.8. For example, if the Retail Price of the book ‘C # Unleashed’=$25.00, then, Equivalent Trade Point Value of this book=$25.00*0.8=20.00 TPV. Step 1 is designed to reflect standard depreciation of the used book.

b) STEP-2: TPV Multiplication Factors based on Book Condition The following is the Standard Conditions and the respective Trade Point Value multiplication factors:

| Book Condition | Equivalent Multiplication Factor |
|---|---|
| Like New | 0.9 |
| Good | 0.8 |
| Average | 0.7 |
| Below Average | 0.6 |
| Poor | 0.5 |

The above book condition multiplication factors is considered while determining the final TPV of the book.

c) STEP-3: TPV Multiplication Factors based on DEMAND-SUPPLY. The Trade Point Value (TPV) calculation of a book will also depend on the supply and demand factors. The various demand and supply factors/scenarios as well as the corresponding TPV calculation factors are as follows:

IF SUPPLY>DEMAND (Supply Greater than Demand)

This condition in the trade cycle occurs, if the number of a particular textbook added by various members in their inventories i.e. ‘My Inventory’ EXCEEDS the number of requests put by the members in their ‘My Requests’ section for the same textbook. For example, the system searches and finds out that a particular textbook with ISBN #12345678 is available in inventories of 10 members in the network, however, the same textbook has been requested by only 5 members in the network. Thus, this is a condition where the supply of a particular book is more than the demand of this book. Hence, the multiplication factor for TPV calculation for this type of a scenario is LESS THAN 1 and it will vary on the basis of the supply/demand ratio, which are as follows:

| | Equivalent |
|---|---|
| SUPPLY:DEMAND RATIO | Multiplication Factor |
| Range => More than 1:1 to 5:1 | 0.9 |
| Range => More than 5:1 to 10:1 | 0.8 |
| Range => More than 10:1 to n:1 | 0.75 |
| (n = infinite) | |

IF SUPPLY=DEMAND (Supply is Equal to Demand). This condition in the trade cycle occurs, if the number of a particular textbook added by various members in their inventories (‘My Inventory’) EXACTLY MATCHES the number of requests put by the members in their ‘My Requests’ section for the same textbook. For example, the system searches and finds Out that a particular textbook with ISBN #12345678 is available in inventories of 10 members in the network and the same textbook has been requested by 10 members in the network. In this case the factor is exactly 1:1.

IF SUPPLY<DEMAND (Supply is LESS than Demand)

This condition in the trade cycle occurs, if the number of a particular textbook added by various members in their inventories (‘My Inventory’) IS LESS THAN the number of requests put by the members in their ‘My Requests’ section for the same textbook. For example, the system searches and finds out that a particular textbook with ISBN #12345678 is available in inventories of 5 members in the network, however, the same textbook has been requested by 10 members in the network. Thus, this is a condition where the DEMAND of this book is MORE THAN the SUPPLY of this book. Hence, the multiplication factor for TPV calculation for this type of a scenario is MORE THAN 1 and it will vary on the basis of the supply/demand ratio., which are as follows:

| | Equivalent |
|---|---|
| SUPPLY:DEMAND RATIO | Multiplication Factor |
| Range => 1:More than 1 to 1:5 | 1.1 |
| Range => 1:More than 5 to 1:10 | 1.2 |
| Range => 1:More than 10 to 1:n | 1.25 |
| (n = infinite) | |

d) STEP-4 (FINAL TPV CALCULATION for the Textbooks):

The FINAL TPV for a textbook is calculated by the following formula: Final Trade Point Value (TPV) of the book=(Retail Price of book)*(Conversion factor for retail price)*(book condition factor)*supply-demand factor.

### EXAMPLE

Retail Price of Textbook with ISBN #12345678=$25.00

Conversion factor for calculating Trade Point Value equivalent to the Retail Price=0.8

Hence, Trade Point Value for the textbook equivalent to the Retail Price=$25.00*0.8=20.00

Condition of the textbook=Good

Multiplication factor applicable for the book condition I.e. ‘GOOD’=0.8

Number of Requests for the Textbook in the network=5

Number of textbooks in the Inventories of members in the network=3

Supply:Demand Ratio=3:5=1:1.6

TPV multiplication factor applicable for the SUPPLY-DEMAND scenario=1.1

Hence. Calculated Trade Point Value (TPV) of the book=Retail Price*conversion factor for retail price*book condition factor*supply-demand factor=25*0.8*0.8*1.1=17.6

3. My Requests

On clicking this link, the member is taken to the ‘My Requests’ section of his account area.

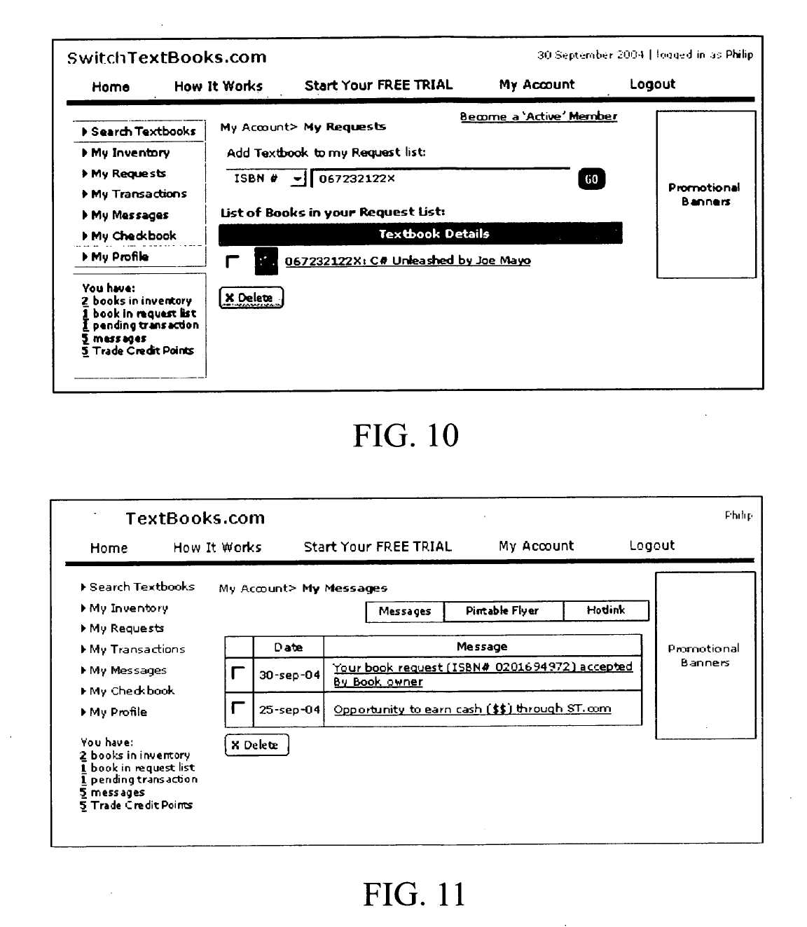

FIG. 10 is a screenshot of the My Requests' Section, which displays a list of all the books that this particular member has added in his request list i.e. the wish list of books, which he needs. A facility is also provided in this section for the member to add additional books in his request list. This book request list of the member is taken into account by the system while calculating ‘Supply Demand Ratio’, ‘Trade Point Value’ of books and for matching book requests and availabilities. The member receives notification from the system whenever a book in his request list becomes available in the network i.e. in the inventories of other members. This is an optional feature for which the Default is set to =“ON”. This option may beset by the user in the ‘My Profile’ area (by turning ‘Book Match e-mail notifications on or off’. Also each email received by the member will also have a small note informing him that he can switch on/off such book match notifications via ‘Update Profile’. While adding a book in the ‘My Requests’ list, the system will check if any book with the same ISBN # exists in his ‘My Request’ list or his ‘My Inventory’ list already or not. If any book with the same ISBN # exists in any of these 2 sections of the member, the system will NOT ALLOW the book addition.

As shown in FIG. 10, the ‘My Requests’ list of the member already displays a book listings which means that this member had added this book to his wish-list earlier. Each existing, book in the member's request list is associated with a checkbox for selecting that record for deletion. Once the member selects the checkbox associated with a request and click on the ‘Delete’ button that request is immediately deleted from his ‘My Requests’ list. If the member clicks on the request link, he is directly taken to the book details page with the inventory listing below (whenever it is available in the network). The member is also able to add a book to his request list via the ‘Add book to my request list’ box on the top of the page. This functionality is similar to the ‘Search Textbooks’ functionality explained earlier. A user can also add a searched book into his ‘Request’ list from ‘the Book details’ page, by clicking the ‘Add to Request’ button from the ‘Book Details’ page, the book is directly added to his request list. As soon as the book is added to his request list, the ‘The ASP Intelligent Trading Engine’ automatically detects this member as one of the members who has requested this book and stores the information. Now, as soon as this particular book becomes available in some other member's inventory, the Intelligent Trading Engine’ automatically detects the MATCH and sends an auto-email notification to the requestor informing him that his requested book is now available in the network inventory. After receiving the auto-notification the member can then go back to his request list, click on the request link and go to the book details page. In the book details page the member is now able to see the ‘AVAILABLE’ inventory(s). He can then select a particular book from the inventory and click on the ‘Send Request’ button. At this point of time the system will check the member status. As soon as this member sends a trade request (for receiving this book) to the owner and the owner ACCEPTS this request, the book is automatically removed from his ‘My Request’ list.

4. My Messages

On clicking this link, the member is taken to the ‘My Messages’ section of his account area. FIG. 11 is a screen print of the My Messages' screen, which has 3 subsections, including a) Messages (default), b) Printable Flyer, and c) Hotlink. The appropriate sub-section where the member is currently in is highlighted.

a. Messages

This is the default sub-section of the ‘My Messages’ section, and it displays a list of all the messages received by the member in a tabular format. The messages is displayed in the list in form of message links, with the latest message on the top. Member can click on the ‘Message’ link to read the detailed message or he is directed to appropriate pages on clicking selected messages. Each message is associated with a checkbox. The member can select the appropriate messages from the list for deletion by selecting the associated checkboxes and then click on the ‘Delete’ button to delete those messages. Two categories of messages are displayed: 1) System generated messages (Auto) and 2) Messages generated by the Administrators of The ASP.

1. System Generated Messages (Auto) are automatically generated by the system and are displayed in the member's ‘My Messages’ section on specific events or actions in the trading cycle. On clicking such system generated auto message links, the members is directly taken to their ‘My Transaction’ page for viewing the details. The events of the trading cycle when these messages are generated include:
Message to ‘Sender’ when he receives a ‘Book Request’ from a receiver.
Message to ‘Receiver’ when his request is either ‘Declined’ or ‘Accepted’ by the ‘Sender’. Requests that are not manually declined are not presented here.
Message to ‘Receiver’ when ‘Sender’ dispatches the book and update the transaction status accordingly.
Message to ‘Sender’ when ‘Receiver’ accepts the book.

2. Messages Generated by the Administrator. This type of messages is manually generated by the Administrator/Administrators of The ASP via the back-end administrative module and is displayed in the member's ‘My Messages’ section.

On clicking these messages, the member is taken to a message details page where he is able to view the message details. This type of messages is NOT be any event or activity specific. Further details on generating this type of messages via the Administrative module is explained in the ‘Admin Module Functionality Specifications’ document.

b. Printable Flyer

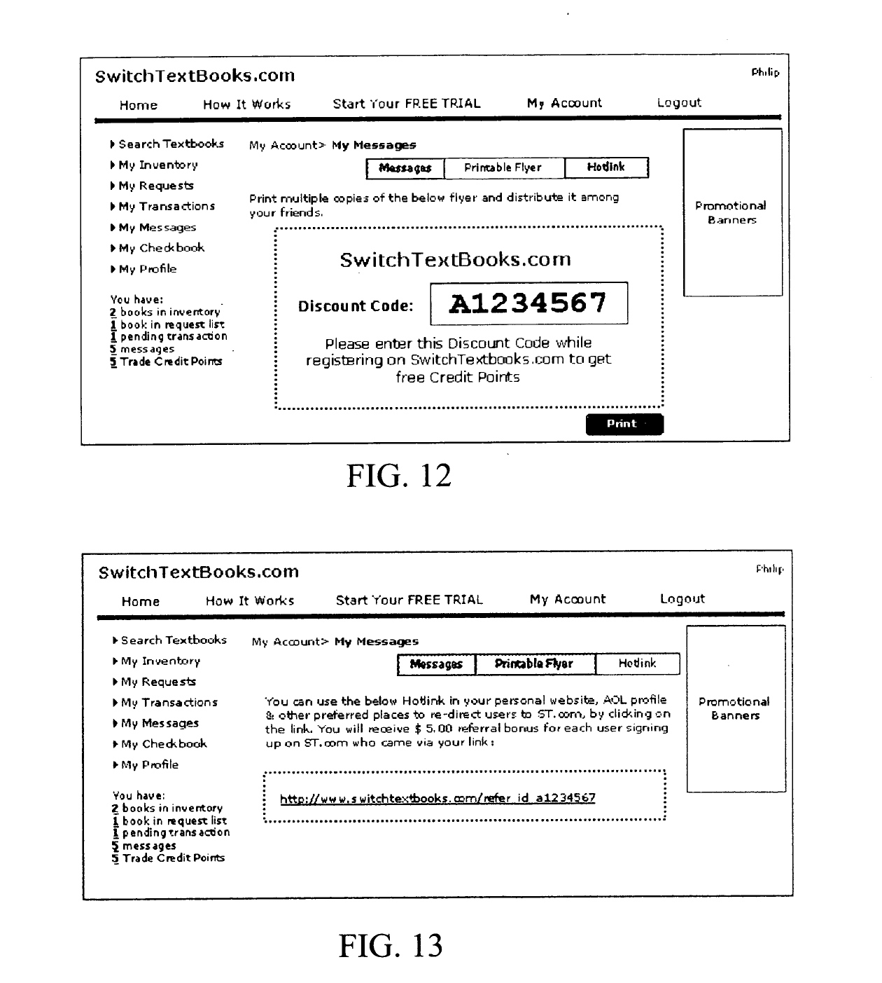

FIG. 12 is an screen print of the ‘Printable Flyer’ sub-section, which allows the user to find a printable ‘Discount Code Coupon’ as shown. The ‘Discount Coupon’ has a 8-DIGIT pre-generated Code with appropriate message for the users who is using this coupon. The 8-DIGIT Code on the ‘Discount Coupon’ is actually the 8-DIGIT member code of the logged in member. The member can distribute this ‘Discount Code’ (Referral Code) to all his friends who are willing to register on The ASP. This ‘Discount Coupon’ distribution will act as a offline promotional activity for The ASP. The member can click on the ‘Print’ button to print the ‘Discount Coupon’ for distribution. On clicking the ‘Print’ button, the member's ‘Default Print Set-up Window’ will pop-up (Not part of the application but specific to the member's machine) and the member is able to print as many discount Coupons as required. As explained earlier, new registrants can enter this discount/referral code in the registration page go receive +5 free ‘Trade Credit Points’ in their checkbook. Also, this member who referred the registrant is ELIGIBLE to receive a $5.00 referral bonus (provided that he is himself is a paid ‘ACTIVE’ member of The ASP and the member who registered using his ‘Referral Code’ becomes a ‘ACTIVE’ member of The ASP by paying the membership fee.

c. Hot Link

FIG. 13 is a screen print of the ‘Hotlink’ section. The ‘Hotlink’ sub-section displays a SINGLE ‘Referral Link’. The member can copy and paste this link to any of his preferred websites, in AOL profile etc. Whenever any user in the Internet clicks on that link he is directly taken to the the ASP website. The application will immediately recognize the reference i.e. with which member's reference has this particular user arrived on The ASP. If the referred user signs-up on The ASP, then the member via whose hotlink this new user arrived on The ASP will receive $5.00 referral bonus in his checkbook.

5. My Profile

On clicking this link, the member is taken to the ‘My Profile’ section of his account area where the member is able to update his Profile Information. The ‘My Profile’ section has 3 sub-sections, which are available as sub-navigation links at the top. In the ‘Update Profile’ subsection, the member is able to update his personal profile, which he filled up during registration, inclusive of credit card info and username/email. Through this sub-section the member is also able to submit membership cancellation request. The 3 sub-sections are as follows:

Update Profile

Change Password and

Update CC

Each of these functionalities is available by a navigation link at the top at top center, and as described in detail below. FIG. 14 is a screen print of the ‘Update Profile’ section, which displays the pre-filled registration form completed during registration process in editable format. The member is able to edit any form field value and can click on the ‘Update’ button to save the change. While saving modifications to the profile (if any), field validations are redone, If the member modifies the ‘EMAIL ADDRESS’ which is also the ‘Username’ for the member, the system will check if the modified email address exists in the member database or not. This check is done because the email address should be unique in the database. If the member modifies the ‘Email Address’ in ‘Update Profile’ then the system displays a change password form and will again send a ‘Email address verification’ email to the new email address which the member must verify before he logs in to the account area next time. If the member changes credit card information a separate Update CC form pops up for completion. The credit card number is in a encrypted format and only the last 4 digits of the CC # is viewable in this form. Once the CC number is validated, the new CC Number will replace the old CC Number. If the new CC # CANOT be VALIDATED then the original CC # remains. Thus, when the member is again charged for ‘Renewal Fees’ after completion of annual membership, it is charged on this new CC #. The main Update profile form also includes an additional checkbox for membership cancellation which is ONLY available from 3 WEEKS before the member approaches the ‘1 year. If the member selects the CANCELLATION checkbox and clicks on the ‘Update’ button in the ‘Update Profile’ page, an auto-email is sent to the member with a secured link to cancel the membership. This auto-email is sent after 12 hours from the cancellation request and no earlier. The member can click on this link in the email message to go to the home page, where the reason for cancellation is asked (dropdown option). Once the member selects a reason and submits, the cancellation request is processed and the member record is automatically deactivated within the next 24 hours. An auto-generated email is sent to the member after 7 weeks from the date he chooses to cancels his membership renewal, asking him again to renew his membership. The MyProfile page also has renewal information. Once a member become ‘ACTIVE’ by paying his ‘Annual Membership Fees’, his membership is valid for the next 1 year. The Renewal date of his membership is exactly after 1 year from the date when he became an ‘Active’ member or 1 year from his last renewal date. If the ‘Credit Card Details’ of the member is stored in the ASP Database (only if this member paid membership fees last time via CC), then the system will automatically charge the ‘Membership Renewal Fees’ on his Credit Card on the exact ‘Renewal Date’. While charging the Credit Card for ‘Membership Renewal’, if the CC is found to be invalid, then the system automatically demotes the status of that member record from ‘ACTIVE’ to ‘TRIAL’. Again as a ‘Trial’ member this particular member has to login and renew his membership by paying via new CC or Check or Paypal. If the member modifies the Membership Renewal Date’. If the ‘Credit Card details’ of a member is NOT available in the database i.e. the member paid the membership fees via Check or PayPal last time, then the system will automatically generate an auto-email prior to a specified number of days before the membership renewal date and send the email to the member. The auto-email contains appropriate message asking the member to pay his ‘Membership Renewal Fees’. Once this member logs in to his ‘Account Area’ he will find a ‘Renew your Membership’ link on the top. By following that link, the member can renew his membership by paying via Credit Card. Check or PayPal. If this member's ‘Membership Renewal Fees’ do not arrive on or before the ‘Membership renewal date’, the system automatically demotes this member record from ‘Active’ to ‘Trial’. The ‘Update Profile’ form will also contain a checkbox for switching off all ‘Book Match’ related emails (NOT Trading process related emails) for the member. Before charging the ‘Renewal Membership Fees’ to the member, the system will automatically check for the ‘Referral Bonus’ the member has accumulated in his checkbook. If the checkbook of the member contains any ‘Referral Bonus’ balance, then the system will take into account the ‘Bonus Balance’ while calculating the ‘Renewal Fees’. Thus, for example if the ‘Renewal Membership Fees’ is $19.95 and the ‘Referral Bonus Balance’ in the member's checkbook is $10.00 (2 referrals*$5.00), then the system will deduct the ‘Referral Balance’ from the ‘Renewal Fees’ (i.e. Renewal Fees—Referral Bonus Balance $19.95−$10.00=$9.95) and charge only the remaining amount i.e. $9.95 as ‘Renewal Fees’ to the member.

In another scenario, if the ‘Referral Bonus Balance’ available in the member's checkbook is $50.00 and the Renewal Fees is of $19.95, then the system will NOT CHARGE any additional ‘Renewal Fees’ to the member, however the ‘Renewal Fees’ is adjusted with the ‘Referral Bonus Balance’. Thus, alter deducting the ‘Renewal Fees’ the ‘Referral Bonus Balance’ in the member's checkbook is now $50.00−$19.95=$30.05.

6. Account Management

The member is taken to the ‘Sign-up’ process if the ‘TRIAL’ member clicks on the ‘Be a Active member’ link on the top of the account area once he logs in, or if the ‘TRIAL’ member selects a particular book from the inventory and clicks on the ‘Send Request’ button.

In the sign-up process, the member is directly taken to a ‘Credit Card’ details page, where the member has to enter the ‘Credit Card’ details, edit (if required) the billing address and then accept the ‘Terms and Conditions’ before proceeding for the online CC transaction. The member can also select to pay via ‘Check’ or ‘PayPal’ mode by clicking on the appropriate link at the bottom of the screen. This ‘Credit Card’ details page is a secured page reflecting gateway billing info, and presently Authorize.net is the gateway of choice.

The complete form field description along with validation rules is as per the following table:

TABLE 2
‘Credit Card Payment’ Form Fields

| | | | | |
|---|---|---|---|---|
| | Field | | | |
| # | Name | Type/Size | Description | Validation Rules |

Credit Card Details:

| | | | | |
|---|---|---|---|---|
| 1. | Card Type | Dropdown list | The commonly | Mandatory (must select |
| | | box containing | accepted CC types are: | a option from drop- |
| | | all Credit Card | Master Card | down) |
| | | Type options | Visa | |
| | | accepted by | Amex | |
| | | The ASP | | |
| 2. | Credit Card | Numeric/16 | Enter the exact CC | Mandatory (not null) |
| | Number | | number | Minimum and maximum |
| | | | | 16 numbers |
| 3. | CVV Number | Numeric/3 | Enter CVV number | Mandatory (not null) |
| | | | found on back of Credit | Minimum and maximum |
| | | | Card | 3 numbers |
| 4. | Expiration | 2 dropdown | Select month and year | Mandatory (must select |
| | Date | list boxes for | of credit card expiry | month and year options |
| | | Month and | | from dropdown) |
| | | Year selection | | |

Credit Card Billing Address:

| | | | | |
|---|---|---|---|---|
| 5. | Address 1 | Alphanumeric/ | This field is pre-filled | Mandatory (not null) |
| | | 100 | with the corresponding | |
| | | | shipping address field | |
| | | | value entered during | |
| | | | registration. Member is | |
| | | | able to EDIT these | |
| | | | details to match the | |
| | | | address stored with his | |
| | | | Credit Card company. | |
| 6. | Address 2 | Alphanumeric/ | -Same as above- | Optional |
| | | 100 | | |
| 7. | City | Alphanumeric/ | -Same as above- | Mandatory (not null) |
| | | 50 | | |
| 8. | State | Dropdown list | -Same as above- | Mandatory (must select |
| | | box containing | | a state from drop-down) |
| | | all US state | | |
| | | names | | |
| 9. | Zip Code | Alphanumeric/ | -Same as above- | Mandatory (not null) |
| | | 15 | | |

Accept ‘Terms and Conditions’:

| | | | | |
|---|---|---|---|---|
| 10. | Accept Terms | Checkbox | Select checkbox to | Mandatory (must select |
| | and Condition | | accept the ‘Terms and | the checkbox) |
| | | | Conditions’. Member | |
| | | | can read the ‘Terms | |
| | | | and Conditions’ in a | |
| | | | new pop-up window by | |
| | | | clicking on the link. | |

Once the member fills-up the above ‘Credit Card details’ and click on the ‘Submit’ button, the information is immediately passed on to a secured payment gateway’ by the application, such as Authorize.net. The member is immediately charged the Annual Membership Fees via this transaction. If the ‘Credit Card Transaction’ is successful, the member is immediately taken to the ‘Transaction Confirmation’ page. If the ‘Credit Card Transaction’ is unsuccessful, the member is returned back to the Credit Card page with the error message. The member can again enter correct CC number or enter a new CC details to proceed again. Once the member's CC is successfully charged, the system automatically updates the status of the member record in the ‘Member Database’ from ‘TRIAL’ to ‘ACTIVE’. The system also sends an auto-email to the member's email address confirming the successful transaction and informing him about his ‘Active Membership’ status. As a ‘ACTIVE’ member he is allowed to request for books from other members in the network and is able to receive books.

7. My Transactions (and Trading Cycle)

On clicking this link, the member is taken to the ‘My Transactions’ section of his account area. The ‘My Transactions’ section displays a list of all the transactions which the member has taken part in, both as a sender and a receiver. The member is also able to find all the pending as well as closed transactions in this section. All the transactions in this particular section are SORTABLE by date, TPV value and sender/receiver by clicking on the appropriate columns. Through this section, the member is able to take appropriate actions against all the pending transactions throughout the trading process.

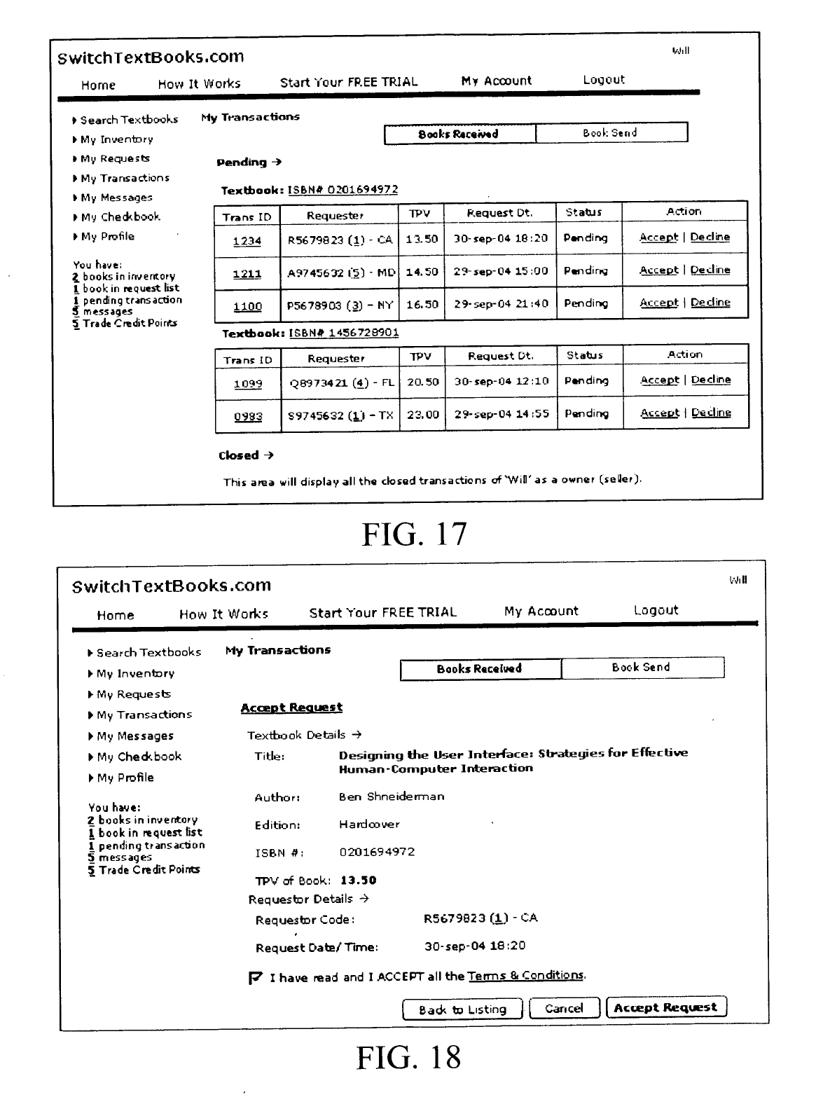

FIG. 17 is a screen print of the My Transactions page. Having now described the user interface, a trading cycle will now be described between a book receiver and book owner/sender (Book Receiver=Member who requests and receives book from owner, Book Owner/Sender=Member who has the book in his ‘Inventory’ accepts the receivers request and send book to receiver).

STEP-1: Book Details Page with Available Inventory List

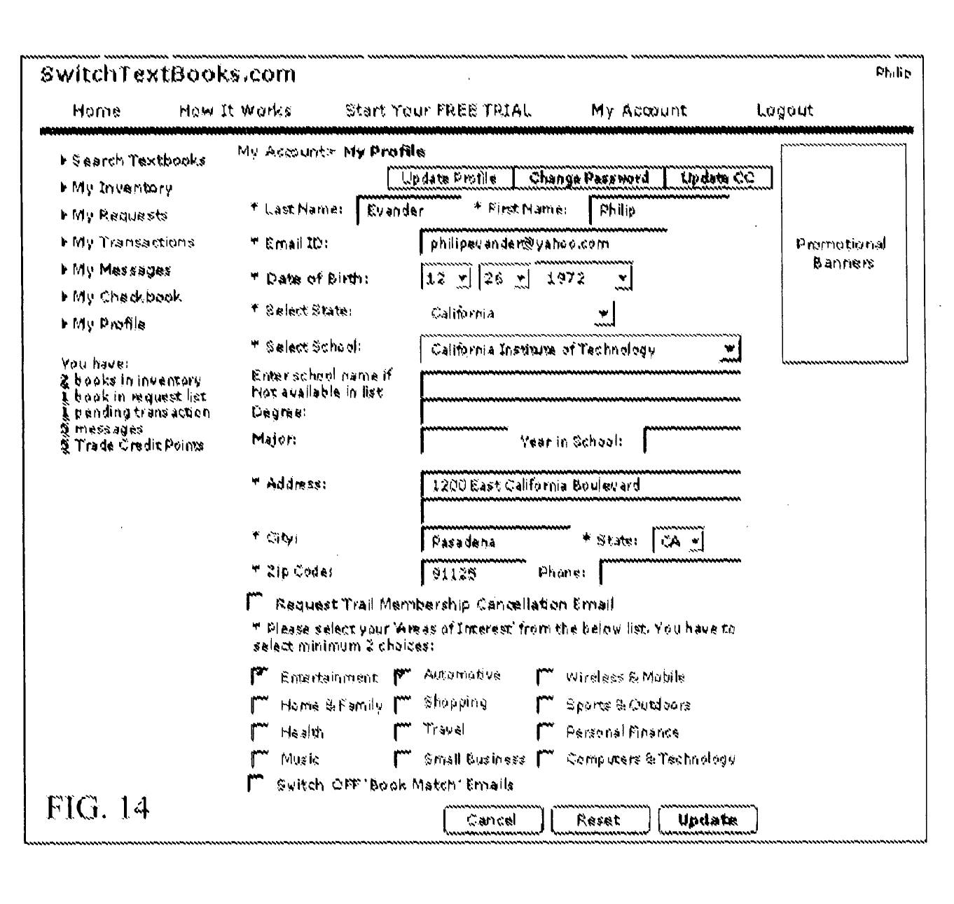

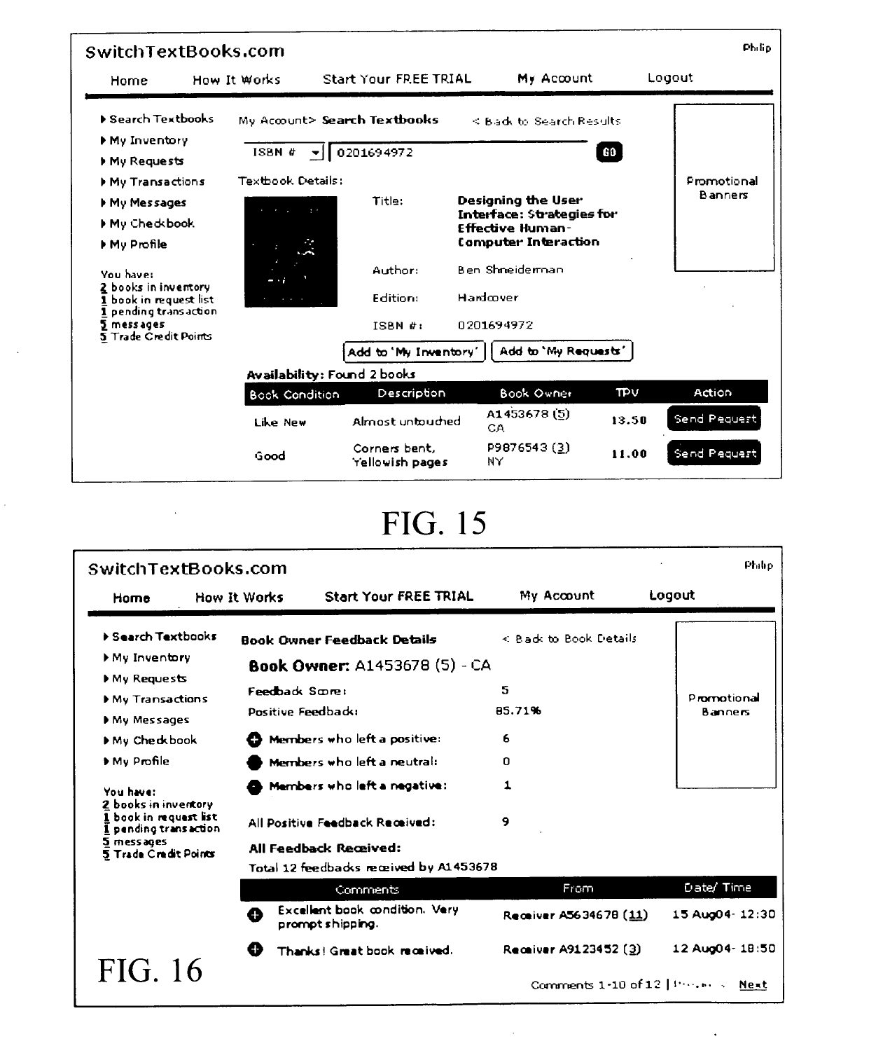

Book ‘Receiver’ searches for book and goes to the ‘Book Details Page of FIG. 15’. The ‘Book Details’ page displays the ‘Available Inventory’ below the book details. Two books where found in the inventory of other members. Each book details in the ‘Inventory list’ is associated with the following details:

Book Condition—As selected by the owner while adding it to his inventory.

Book Description—As entered by the owner while adding it to his inventory.

Book Owner—The name of the book owner is hidden from the receiver at this point and only the 8-digit member code of the owner is displayed.

Owner Rating—This is displayed in brackets as a linked number beside the book owner code.

Location of the Owner—The state of the owner i.e. where this owner is located is displayed in short below the owner code. For example, CA=California, NY=New York

TPV—The equivalent Trade Point Value’ of the book is displayed. This TPV value is deducted from the receiver's checkbook and the same value is added to the owner's checkbook if the trade is completed.

Send Request Button—The receiver can click on this button to send a request to the owner.

Now, the receiver can select his preferred owner for sending a request on the basis of multiple factors like book condition. TPV value of book, location of owner or rating of the owner. Thus. ‘Member Rating’ is one of the major factors, which is considered by the ‘Receiver’ while selecting a ‘Owner’ or vice versa. In this case scenario, lets consider that the ‘Receiver’ first want to check out the ‘Member Rating’ of the owner before sending him a book request. Hence, the receiver clicks on the ‘Member Rating Number link’ associated with the appropriate owner book-listing row in the inventory list to go to the ‘Member Rating Details’ page of the owner. FIG. 16 is a screen print of the ‘Member Rating’ details page, which displays the following details:

8-Digit Member Code of the Member (To mask identity . . . once the trade is complete the full name of the member can be displayed).

Feedback Score: The feedback score represents the number of members that are satisfied doing business with a particular member. It is usually the difference between the number of members who left a positive rating and the number of members who left a negative rating. In the example shown above, the feedback score is 6−1=5

Positive Feedback: This represents positive ratings left by members as a percentage. In the example shown above, the positive feedback percentage is 6 divided by 6+1=85.71%.

Members who left a positive: This represents the number of unique members who have given this member a positive rating. If a member has had several transactions with this member and leaves more than one positive rating, they will still only count once in this number. In the example shown above, 6 unique members have left a positive rating.

Members who left a negative: This represents the number of unique members who have left a negative rating for this member. If a member has left multiple negative ratings they will still count only once in this number.

All positive feedback received: This represents the total number of positive feedback received for all transactions, including repeat customers, in this example, this member has received 9 positive ratings.

Further Details on Feedback Scores: Each member of the ASP network that a member trade with has the ability to leave feedback. In order to make that contribution fair and safe, each member can only affect another member's feedback score by +1, 0, or −1. The feedback score represents the number of members that are satisfied doing business with this member. It is the difference between the number of members who left a positive rating and the number of members who left a negative rating. A rating from a unique member only contributes once to another member's score. For example, when a member leaves 3 positive ratings for another member (for 3 different transactions), the other member's score increases only by +1. Each feedback details in the list is associated with the following details:

Comment Details: Comment From Member—Member Code, Rating link and Location Date and Time when Comment Received.

STEP-3: Receiver Sends Book Request to Owner

Now once the ‘Receiver’ has checked out the ‘Member Rating’ of a particular owner he selects him as the preferred sender decides to send that owner a ‘Book Request’. So, now the ‘Receiver’ will just have to click on the ‘Send Request’ button associated with his preferred owner listing in the book details page (Refer to FIG. 15). Once the ‘Receiver’ clicks on the ‘Send Request’ button, the system checks whether the ‘Receiver’ is a ‘Trial’ member. If the ‘Requestor’ is a ‘Trial’ member then he is directly taken to the ‘Sign-Up’ process. If the ‘Receiver’ is a ‘ACTIVE’ member, then the system accepts his request and forwards the request to the book ‘Owner’. As soon as the ‘Book Request’ is forwarded to the Owner, the Receiver is shown a ‘Confirmation Message’. Simultaneously, the system also sends an ‘Auto Email’ to the Owner informing him about the request for a book from his inventory. This request is added to the ‘My Transactions’ sections of both the ‘Receiver’ and ‘Owner’ as a pending request. The Owner also receives a system generated message alert in his ‘My Messages’ section.

STEP-4: Receiver Views Pending Request Status on his ‘My Transactions’ Section

Once the ‘Receiver’ has sent the book request to the owner, this request gets added to his ‘My Transactions’ section as ‘Pending Request’ (See FIG. 17). The Receiver can now go to his ‘My Transactions’ section to checkout the ‘Pending Request’ The ‘My Transactions’ section has 2 sub-sections, which are available as sub-navigation links at the top. The 2 sub-sections are:

Books Received—This sub-section contains all the transactions in which this member acted as a book Receiver i.e. he has received or is receiving books.

Books Send—This sub-section contains all the transactions in which this member acted as a book SENDER i.e. he has sent or is sending books.

Also, each of the sub-sections has 2 folders which are as follows:

Pending—This folder contains all the transactions, which are not yet complete i.e. pending or under processing. The tracking information of the pending requests can be viewed by the receiver via the transaction-listing page, only after the sender provides the tracking details.

Closed—This folder contains all the transactions, which are completed.

Additionally, each sub-section can have another folder which can be called ‘Disputed’ i.e. this folder contains all the transactions marked as disputed transactions.

Now, as shown in the above screen, the Receiver has sent a book request to the owner, hence, that request appears as a transaction in the ‘Book Received’ subsection of the Receiver under the ‘Pending’ Folder.

The ‘Pending, Transaction’ Request is associated with the following details as shown in FIG. 17:

Unique Transaction ID

Book Details—This column will display the ISBN # of the requested book as link. The book details can be viewed by clicking on this link.

Book Owner—This column will display the 8-digit member code of the ‘Owner’ along with the ‘Member Rating’ link and Member location in short.

TPV—Trade Point Value of the requested book.

Request Date—The date and time when the request was sent.

Status—This column shows the transaction status. This transaction status will change as the trade process progresses. The current transaction status is PENDING.

Action—This Column displays the ‘Action’ link for the Receiver. However, because the status of the transaction is currently ‘Pending’, hence there is no action link available for the Receiver.

STEP-5: Book Owner Views the Book ‘Request’ sent by ‘Receiver’

Once the ‘Receiver’ has sent the book request to the owner, the owner comes to know about the request in 2 ways: either by an auto-email sent by the system informing him about the request, or an Alert message in his ‘My Messages’ section

The Owner can go the ‘My Messages’ section and click on the appropriate message link to go to the ‘Transaction listing’ page or he can directly go via the ‘My Transactions’ link on the left navigation panel. The ‘Owner’ will view the request sent by the Receiver in his ‘Book Send’ sub-section under the ‘pending’ folder.

If the ‘Owner/Sender’ has multiple requests for a book, then the ‘pending transactions’ folder of the owner/sender will display ‘Book-wise Pending Requests’. For example, in FIG. 17 there are total 5 requests received by the owner/sender for books in his inventory, out of which 3 requests are for the book ISBN #0201694972 and 2 requests are for the book ISBN #1456728901. The Pending Transaction details are also very similar to the details viewed by the Receiver (explained earlier), except that the owner is able to view the member code, rating and location of the requester, and the Action link column for the ‘Owner’ will display 2 links:

Accept—By clicking this link the owner can accept the receiver's request.

Decline—By clicking this link the owner can decline the receiver's request.

Note that the Owner can receive multiple requests for the same book in his inventory. In case of multiple requests, the pending folder in the above screen will display up to the first 15 requests. However, the Owner can ACCEPT only 1 Request per book i.e. for the same book in his inventory. If the ‘Book Owner’ accepts one of the requests from the list all the other remaining requests will fall-off immediately. The ‘Owner’ will NOT receive an email each time a book request is made. The ‘Owner’ has to ACCEPT a request within 36 hours. If a member sends requests for the same book (common ISBN #) to multiple senders (for example, he sends requests for same book to 3 different senders) and one of the senders accepts the receiver's request, the other 2 requests by the receiver will automatically fall-off. Note that multiple requests for the same book by one member will not affect demand supply factor in the TPV calculation.

STEP-6: Accept Request by Owner

Once the Owner views all the pending requests for a single book in his inventory, he selects only one request from the list and clicks on the associated ‘ACCEPT’ link. Immediately, the Owner is taken to the ‘Accept Request’ details page as shown in FIG. 18. In this page the Owner can view the details of requested book as well as the requestor and can Accept the request by clicking on the ‘Accept Request’ button. However, the Owner has to first accept the terms and conditions regarding the shipping process before accepting the request. The Owner accepts the request by clicking on the ‘Accept Request’ button. Once the ‘Sender’ clicks on the ‘Accept Request’ link, a pop-up window with a disclaimer provided by The Administrator will appear, that they must click I agree again. This will help enforce that the book is shipped within 72 hours or some other measured period.

Thus, as soon as the Owner accepts a request by selecting a appropriate ‘Receiver’, the system automatically DECLINES all the other requests received for the same book in the ‘Owner's’ inventory. Notifications via my messages are not sent to all the ‘Declined’ members in this scenario. Once the book Owner accepts the request, the following events occur:

All the other pending requests except the one accepted by the owner gets automatically declined and those declined requestors are notified via email.

When a ‘Receiver’ submits a request to the ‘Sender’ and the ‘Sender’ accepts the request then the following events happens immediately: Receiver receives (−) TPV equivalent to the TPV of the book being traded, in his checkbook, Sender receives (+) TPV equivalent to the TPV of the book being traded, in his checkbook.

The status of the pending request is now updated to ‘ACCEPTED’.

The ‘Receiver’ whose request got accepted is immediately informed via email as well as via message alert in his ‘My Messages’ section.

The accepted book is removed automatically from the Owner's Inventory list.

The accepted book is removed automatically from the accepted ‘Receiver's’ Request list (if he had added that in his request). Once a transaction is locked i.e. the ‘Sender’ accepts a request by the ‘Receiver’, the system displays the email address of the receiver to the sender and vice versa in the ‘Transaction listing’ page of the sender and the receiver. This helps in solving disputes mutually between the sender and the receiver.

STEP-7: ‘Owner’ Views Updated Transaction Status and Receiver's Shipping Details

Once the ‘Owner’ accepts the book request the ‘My Transaction’ page view for the ‘Owner’ gets refreshed to show the new transaction status. The status of the transaction as shown in FIG. 17 will change and the following details are now available to the Owner:

Receiver Details—As soon as the Owner has accepted the request, he is able to view the name of the ‘Receiver’ in the ‘Requestor’ column. On clicking the ‘Receiver's Name’ a small pop-up window will open up which will display the detailed ‘Shipping Address of the Receiver.

Status—The status of the transaction has been automatically updated to ‘Request Accepted’.

Action Link—The Action link has been changed to Enter Shipping Details.

Shipping Time Counter—In addition there is ‘Shipping Time Counter’ which will AUTOMATICALLY COUNT DOWN i.e. show the time left (in hrs.) for shipping the book. The default shipping deadline is 72 hours from the time of request acceptance.

STEP-8: ‘Receiver’ views the ‘Accepted Transaction’ Status in his ‘My Transactions sections

Once the ‘Owner’ accepts the book request of the ‘Receiver’ the ‘Receiver’ is informed via email as well as message alert. The ‘Receiver’ can now go to his ‘My Transactions’ section and view the updated transaction status which will appear in FIG. 17 as “Request Accepted (Not Shipped Yet)”. The ‘Status’ of the Transaction has now been automatically updated to ‘Request Accepted (Not Shipped yet)’ by the system, which means that the ‘Owner’ has accepted the ‘Book Request’ but has NOT shipped the book yet.

When tracking information is provided by sender, this is viewable here by receiver. Also, on acceptance of request by the Owner, the ‘Owner’ column associated with the transaction listing automatically displays the name of the Owner. However, the address of the owner will NOT be displayed (hidden) to the Receiver.

If the owner had declined the request, then this status would have been ‘DECLINED’ along with a link to view the comments provided by the owner. Also in case of declined request, the receiver would find a link in the action column to REMOVE this declined request from his pending folder.

STEP-9: Book ‘Owner’ Ships Book and provides ‘Tracking Details’

Once the ‘Owner’ accepts a book request he will get 72 hours to ship the book to the ‘Receiver’. Also, the book Owner has to bear the ‘Shipping Charges’ for shipping the book to the Receiver. The the ASP application will NOT have any functionality related to ‘Shipping Charges’ which is an entirely offline activity. Once ‘Owner’ has shipped the book, then he can go to his ‘My Transactions’ area and click on the ‘Enter Shipping/Tracking Details’ link associated with the specific pending transactions listing. The ‘Owner’ has to enter’ the Tracking Details before the end of the 72 hours deadline (displayed by the Time Counter). On clicking the ‘Enter Shipping Details’ link, the ‘Owner’ is taken to the ‘Tracking Details’ page where he can provide the complete shipment tracking details. In the ‘Shipping Details’ page, the Owner has to provide the following information (all fields are mandatory):

Shipment Tracking Number—The ‘Shipment Service Provider/Courier Company’ provides a ‘Shipment Tracking Number’ by which the shipment's exact status/location can be tracked. The Owner has to enter that particular information here.

Shipment Provider—The Owner can select the appropriate Shipment Provider name (via whom he has sent the shipment) from this dropdown list box. E.g.—UPS. Fedex etc.

Shipment Date—The Owner can select the date when he has dispatched the Shipment from this field.

Once the Owner has provided all the mandatory ‘Shipment/Tracking Details’, he can click on the ‘Confirm’ button to confirm the shipping details. Once the ‘Shipping/tracking Details’ is confirmed, the Owner is taken back to the ‘Transaction Listing’ page, which will display the updated transaction status. There are three possible outcomes here:

Scenario #1: If the Owner confirms the ‘Tracking Details’ within the 72 HOURS DEADLINE PERIOD the following events will occur:

The ‘Transaction status’ is updated from ‘Request Accepted (Not yet shipped)’ to ‘BOOK SHIPPED’.

Book Owner/Sender receives (+) 5 TPV Points as ‘BONUS’ for providing shipment tracking information. These ‘Bonus’ points are in addition to the (+) TPV points equivalent to the book TPV, which he had already received when he accepted the ‘Receiver's’ request.

An auto-email is sent to the Receiver notifying him about the ‘Shipped’ status. Additionally a message alert is also displayed in the Receiver's ‘My Messages’ section.

Scenario #2: If the Sender/Owner is UNABLE/FAILS to provide the TRACKING INFO within the specified 72 hrs time limit, the following thing happens:

The transaction is CANCELLED. The CANCELLED transaction is removed from the ‘PENDING’ transactions list of both the Sender and the Receiver. This particular transaction is assigned a ‘Cancelled’ transaction Status.

Immediately after the sender fails to provide the ‘Tracking Info’ within 72 hours, the (+) TPVs equivalent to the book value, which were added to the Sender's checkbook when he accepted the request (of the Receiver), is immediately (automatically) deducted from his checkbook. Simultaneously, the ‘Receiver’ is CREDITED BACK the (+) points in his checkbook (equivalent to the book TPV) which were deducted from his checkbook when his request was accepted.

The ‘Sender’ receives NO bonus TPVs.

On CANCELLATION of transaction the book is NOT added back to the respective inventory list and request list of the ‘Sender’ and the ‘Receiver’, but it just falls-off.

An auto-email is sent to the Receiver notifying him about the ‘Cancellation’ status. Additionally a message alert is also displayed in the Receiver's ‘My Messages’ section.

Scenario #3: If the Sender/Owner SHIPS BOOK but is UNABLE to provide the TRACKING INFO within the specified 72 hrs time limit, the following thing happens:

The same CANCELLATION process and point adjustments happen as explained previously. However, it's the ‘Sender's’ LOSS and the ‘Receiver's’ GAIN. The ‘Sender’ can report this to The ASP Administrator. The Admin can confirm this with ‘Receiver’, solve the dispute between both the parties and then manually adjust checkbooks of both the sender and receiver via the ‘Admin Module’.

STEP-10: Receiver Views the ‘BOOK SHIPPED’ Transaction Status

Once the ‘Owner’ has confirmed the ‘Shipping Details’, the Receiver receives the notification via an auto-email as well as a message alert in his ‘My Messages’ section. The ‘Receiver’ will now be able to view the ‘Updated Status’ of the transaction along with a new action link in the transaction listing page:

Status—The ‘Receiver’ will now be able to view the new updated status of the transaction i.e. ‘Book Shipped’.

View Tracking Details—The status column will now be associated with a ‘View Tracking Details’ link. On clicking this link the ‘Receiver’ is able to view the ‘Shipment Tracking Details’ provided by the Owner is a separate pop-up window. The Receiver can use the shipment tracking number provided by the Owner to find out the exact position of the shipment via the ‘Shipment Service Provider's’ website.

Action Link—The transaction listing will now also display a new action link for the Receiver i.e. Confirm Book Receipt. The Receiver is able to confirm the receipt of the book via this link, once he receives the physical book delivery.

STEP-11: Receiver CONFIRMS ‘Book Receipt’

The RECEIVER has 15 days after the SENDER provides the ‘Tracking Information’ to CONFIRM the book Receipt. There are two possible outcomes here:

Scenario #1: If the RECEIVER confirms the receipt of the book within the 15 days deadline, then the following activities happens:

The RECEIVER can select the ‘Wrong Book’ option while accepting the book. In that case the transaction is stored as DISPUTED transaction.

The Administrator can adjust the checkbooks of both the receiver and sender as part of the dispute process.

After the receiver accepts the book receipt (right or wrong), the transaction is removed from ‘Pending’ status to either CLOSED or DISPUTED status.

Scenario #2: If the RECEIVER DOES NOT CONFIRM the book receipt within the stipulated 15 days timeline, then the following activities happens:

The ‘Transaction’ status is automatically changed from ‘PENDING’ to ‘CLOSED’.

The RECEIVER is no longer able to report the receipt of Wrong book (if any) i.e. he is NOT able to access the ‘Confirm Book Receipt’ action link in screen 37 and thus the ‘Dispute’ process is NOT applicable in this case.

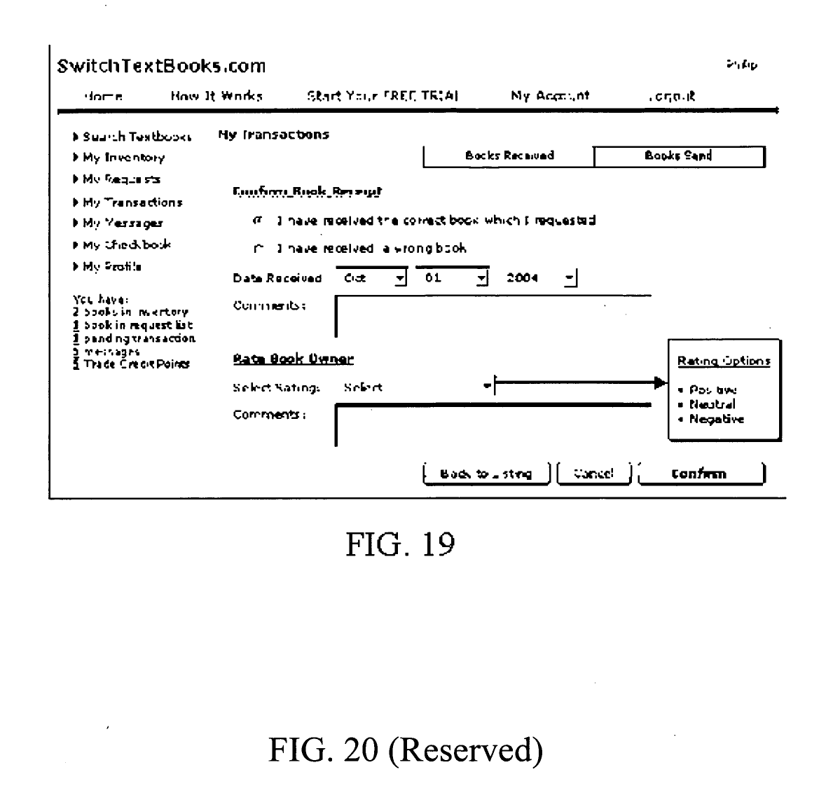

The ‘Book Receipt’ acceptance functionality is explained below. Once the ‘Receiver’ receives the physical delivery of the book, he has to confirm the book receipt. However, as explained above, if the 15 days limit for accepting the book is over then the receiver is no longer able to access the ‘Confirm Book Receipt’ link, because the transaction is automatically closed after the 15 days period. Within the 15 day window, on clicking the ‘Confirm Book Receipt’ link, the ‘Receiver’ is taken to the ‘Confirm Book Receipt Details’ page as shown in FIG. 19. In the ‘Confirm Book Receipt’ page, the Receiver has to select/enter the following details before confirming the receipt:

Select any one of the radio buttoned options for Correct/Wrong Book Received (Mandatory selection)

I have received the correct book, which I requested—The Receiver will select this option if he has received the correct book from the ‘Owner’.

I have received a wrong book—The Receiver will select this option if the Owner has sent a wrong book to him.

Date Received—The Receiver has to select the date when he received the book. This field selection is mandatory.

Comments—The Receiver can enter comments about the book he received from the Owner. This field is optional.

In the ‘Confirm Book Receipt’ page, the Receiver is also able to the ‘Rate the Book Owner’, which is as follows:

Select Rating—The Receiver can select a Rating for Owner from the drop-down list. The rating options are as follows: Positive, Neutral and Negative (

Enter Comment—The Receiver can also enter a comment about the Owner/transaction here.

However, it is not mandatory for the Receiver to rate the Owner at this point of time. He may decide to rate the Owner anytime within the next 60 days. If the Receiver does not rate the owner at this point of time, a link is available in the appropriate ‘Action’ column in transaction listing page for rating the owner. The Receiver can anytime click on this link to rate the owner within the next 60 days. Once the Receiver has rated the owner this link will not be available anymore. Once the ‘Receiver’ has filled up the mandatory fields in the ‘Confirm Book Receipt Details’ page, he can click on the ‘Confirm’ button in screen 38 to submit the confirmation. Once the Receiver ‘CONFIRMS’ the Receipt of the book the following actions/events occurs:

If the Receiver has selected the option ‘I have received the correct book, which I requested’, then the status of the transaction changes from ‘PENDING’ to ‘CLOSED’ and the transaction is removed from the ‘Pending’ folders of both the Receiver and the Owner and put into their respective ‘Closed’ folders. An auto-email is sent to the Owner informing him about the ‘completed transaction’ status along with an alert message in his ‘My Messages’ section. The rating of the Owner is updated on the basis of the ‘Rating’ provided by the Receiver (if applicable).

If the Receiver has selected the option ‘I have received a Wrong Book’, then the status of the transaction is updated from ‘PENDING’ to ‘DISPUTED’ status and is put in respective ‘Disputed’ transaction folders of the ‘Receiver’ as well as the ‘Owner’. An auto-email is sent to the Owner informing him about the ‘Disputed transaction’ status along with an alert message in his ‘My Messages’ section. Simultaneously, the system also sends an auto-email to the ASP Administrator informing him about the disputed transaction. The rating of the Owner is updated on the basis of the ‘Rating’ provided by the Receiver (if applicable).

In case of such ‘DISPUTED TRANSACTIONS’, the ASP Administrator team will discuss the matter (Offline Activity) with both the ‘Receiver’ and the ‘Owner’ and then the Administrator is able to manually adjust the checkbooks of the respective members involved in that transaction via the ‘Admin Module’.

STEP-12: ‘Completed’ Transaction View by both Receiver and Owner

In case the transaction cycle has been completed successfully, the page views by the ‘Receiver’ and the ‘Owner’ are as follows.

The Receiver's transaction page (FIGS. 17 & 18) have the following details:

The trade was closed successfully; hence the transaction record is automatically shown under the ‘Closed’ folder. The transaction status has been updated to ‘Received’. If Receiver has not yet rated Owner, then a ‘Rate Owner’ link is available in the ‘Action’ column for the next 60 days. Once he rates Owner, then this link will not be shown anymore.

Updated information in the summary box (blue box below left navigation): The pending transaction number and TPV value in Receiver's checkbook also changed automatically. Receiver now has (−) ve Credit Points (5−13.50=−8.5) in his checkbook. Receiver won't be allowed by the system to receive any more books until and unless he ships a book from his own inventory. This updated points status is displayed immediately after the ‘Sender’ has accepted the request.

The Owner's transaction page has the following details:

The trade was closed successfully; hence the transaction record is automatically shown under the ‘Closed’ folder. The transaction status has been updated to ‘Received’. The Owner will not be able to Rate the Receiver and hence no action link. Updated information in the summary box (blue box below left navigation): The trade has been successfully completed hence there are NO pending transactions and also Will's checkbook shows a increase in TPVs by +13.50 points which he earned from this transaction (5+13.50=18.50).

Please note that this updated information in the ‘Owner's Summary Box’ is displayed immediately after the ‘Sender’ has accepted the request, because he receives the (+) TPVs equivalent to the book value at point of request acceptance.

8. My Checkbook

On clicking this link, the member is taken to the ‘My Checkbook’ section of his account area The ‘My Checkbook’ section has two different checkbooks or subsections which area as follows:

Trading Checkbook: TPV points earned/paid during trading of textbooks.

Financial Checkbook: Referrals, return shipping credits etc.

The ‘My Checkbook’ section displays the current account balance and details of all the (+) and (−) ‘Trade Credit Point’ transactions that has happened.

FIG. 20 (Reserved)

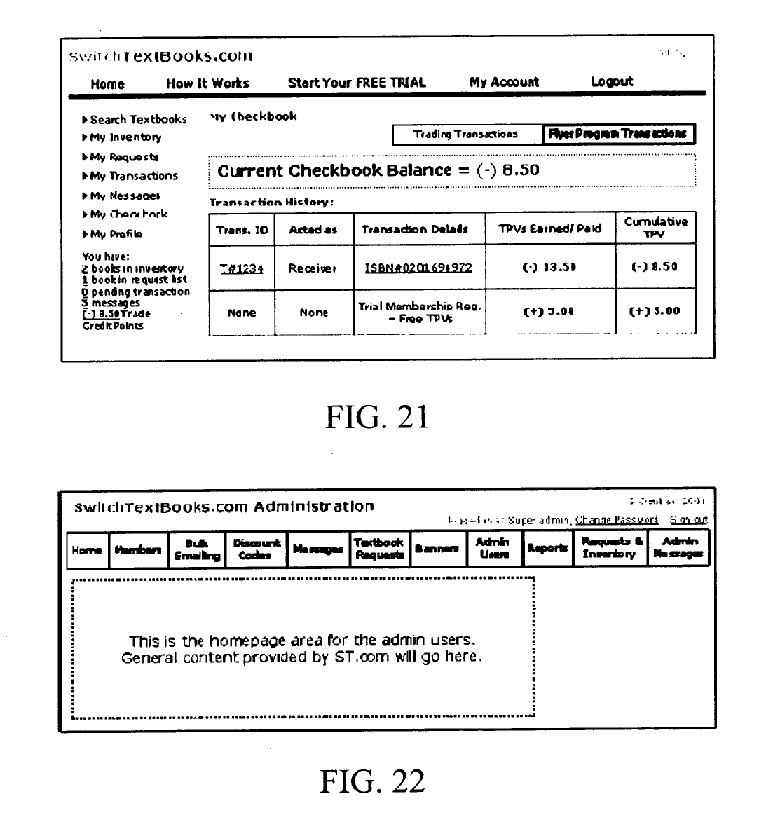

FIG. 21 is a screen print of the ‘Trading Transactions’ sub-section functionality, which is described in the context of the same Receiver and Owner trading cycle explained above. The ‘Trading Transactions’ sub-section of the Receiver displays the following details:

Current Checkbook Balance—This area displays the overall current TPV points il this member's trading checkbook i.e. (−) 8.50.

Transaction History—Below the ‘Current Checkbook Balance’ the complete trading transaction history of the member is displayed. If the history runs into multiple pages then appropriate page navigation is provided. Each transaction record contains the following details:

Transaction ID—All trading transaction records are associated with transaction ID. However, if the member has received free TPVs during registration then that record will not have any transaction ID.

Acted As—This column will display the member's role for a particular transaction i.e. he acted as a Receiver or a Sender. For free TPV point transaction this column is not applicable.

Transaction Details—This column will describe the transaction. If the transaction was an actual book trading transaction then the transacted book details link is provided here. If the transaction was related to free TPV on registration then it is mentioned in the column (no link).

TPVs Earned/Paid—The positive or negative TPVs received against the transaction by this member. If the member acted as a receiver then his corresponding TPV is negative and if as a sender then positive TPV.

Cumulative TPV—Each transaction record is associated with a ‘Cumulative TPV column which will display the cumulative TPV balance in the checkbook at the end of that particular transaction.

In the example shown in FIG. 21, the Receiver just completed his first transaction in which he was a book receiver. This Receiver initially had 5 TPVs in his checkbook, which he earned by the way of registering for the trial membership. Hence his Cumulative TPV at that point was +5. Now, the member took part in a transaction in which he received a book from the owner and hence as a receiver he earned NEGATIVE points equivalent to the TPV of the book he received i.e. 13.50. Hence after the transaction the Cumulative TPV earned by him is =(+5)+(−13.50)=−8.50. If the ‘Current Account Balance’ of the member is in NEGATIVE, then a message is provided in this checkbook page saying ‘You need to ship a single book or multiple books totaling 8.5 pts (value which will give 0 balance or positive value to the checkbook) or greater to be able to receive another textbook or textbooks’. In the meantime, the Member cannot request books.

The Owner's Checkbook (Trading Transactions sub-section) is exactly similar to the ‘Receiver’, however continuing with the same example as before, his current checkbook balance is 18.50 because he received +13.50 TPVs as a Sender for the last transaction which got added to his earlier balance of 5 TPVs. The ‘Sender's’ checkbook will display addition (+) 5 TPVs For the ‘Bonus Point’ he earned in addition to the sent book TPVs after he provided the ‘Tracking Information’.

The Financial Transactions sub-section and functionality is also similar to the ‘Trading Transactions’ sub-section functionality described above with only the following differences: This sub-section displays the current checkbook balance in DOLLARS ($) VALUE earned by this member instead of TPVs. Instead of Trading Transactions, this sub-section will display referral transactions for which the member received the $5.00 Referral Bonus. The ‘Referral Bonus’ transaction can be via Flyer Program or Hotlinks. This checkbook sub-section can also have transactions in which an Administrator adjusts the ‘Annual Membership Renewal Fees’ with the accumulated $ balance in this ‘Financial Transactions’ sub-section of the checkbook i.e. Auto-generate discount upon upcoming membership renewal with positive checkbook balance. An Administrator may also send accumulated ‘Bonus Checks’ to the member on a periodical basis. For example, for members with financial transaction balance >=$10.00, the Administrator may send them physical BONUS checks. After sending the bonus check, the Administrator is able to manually adjust the Checkbook balance ($) via the Admin module.

As explained earlier, a member is blocked from sending a request if his trade checkbook has ‘NEGATIVE’ balance. In case of multiple requests, if one of the requests of the member gets accepted and after acceptance of his request his checkbook turns ‘NEGATIVE’, then all his other requests will automatically fall-off from his own ‘Pending Transactions’ folder in the ‘My Transactions’ section as well as from the ‘Pending Transactions’ folder of the ‘Book Sender’ who received the request.

B. Management Module

A Management Module is also provided for allowing an Administrator(s) to implement and manage the present system, and to provide account management, reports and performance tracking. The Administrative Module is available online at a different URL from the user module. On clicking the ‘Administrative Module’ URL link an Administrator is directly taken to an ‘Admin Login Page’ where login is possible using a predetermined ‘Username’ and ‘Password’. On correct validation, the Administrator is directly taken to an ‘Administrative Module’ homepage.

FIG. 22 is a screen print of the ‘Administrative Module Homepage’: A Top Navigation menu provide navigation links to all the main Administrator utilities within the administrative module. The main admin navigation links are:

Home—Admin Homepage

Members—Membership Management Utility

Bulk Emailing—Bulk Email Management Utility

Discount Codes—Discount Management Utility

Messages—Messaging Management Utility

Textbook Requests—Textbook Requests Management Utility

Banners—Banner Management Utility

Administrators—Administrator Rights Management Utility

Reports—Reporting Utility

Requests and Inventory—Requests and Inventory Management Utility

Admin Messages—Admin Message Management Utility

Above the navigation menu at top corner the ‘Username’ is displayed of the Administrator who is currently logged in. The Administrator is also given a link to ‘Change Password’ where he can replace his ‘Old Password’ with a ‘New Password’ for accessing the admin module, and a ‘Sign Out’ link. There are at least 2 levels of administrative users:

There is a single ‘Super Administrator’ (SA) for the ‘The ASP Administrative Module’. This is the highest level of Administrator for the ‘Administrative Module’ and has access/rights to all the admin utilities. The SA level is able to ADD/MODIFY/DELETE various ‘Administrators’ and assign appropriate rights to them. Additionally, the SA is able to view a list of all internal messages from the Administrators in the ‘Admin Message Management Utility’ and is able to reply to those messages.

There may be multiple ‘Administrators’, level-2 users with restricted access to the Admin Module. The SA can add the ‘Administrators’ and provide appropriate access rights to them. ‘Administrators’ are NOT allowed to access the ‘Administrator Rights Management Utility’, and are able to view/access ONLY THOSE Admin Utilities for which the SA has provided them appropriate rights. “Administrators’ are able to send messages to the SA as well as view reply messages from the SA via the ‘Admin Message Management Utility’.

The Members Link leads to the Membership Management Utility, which is the most important management utility of the Admin Module. On clicking this link on the top navigation bar, the Administrator is taken to the ‘Main Page’ of ‘Membership Management Utility’.

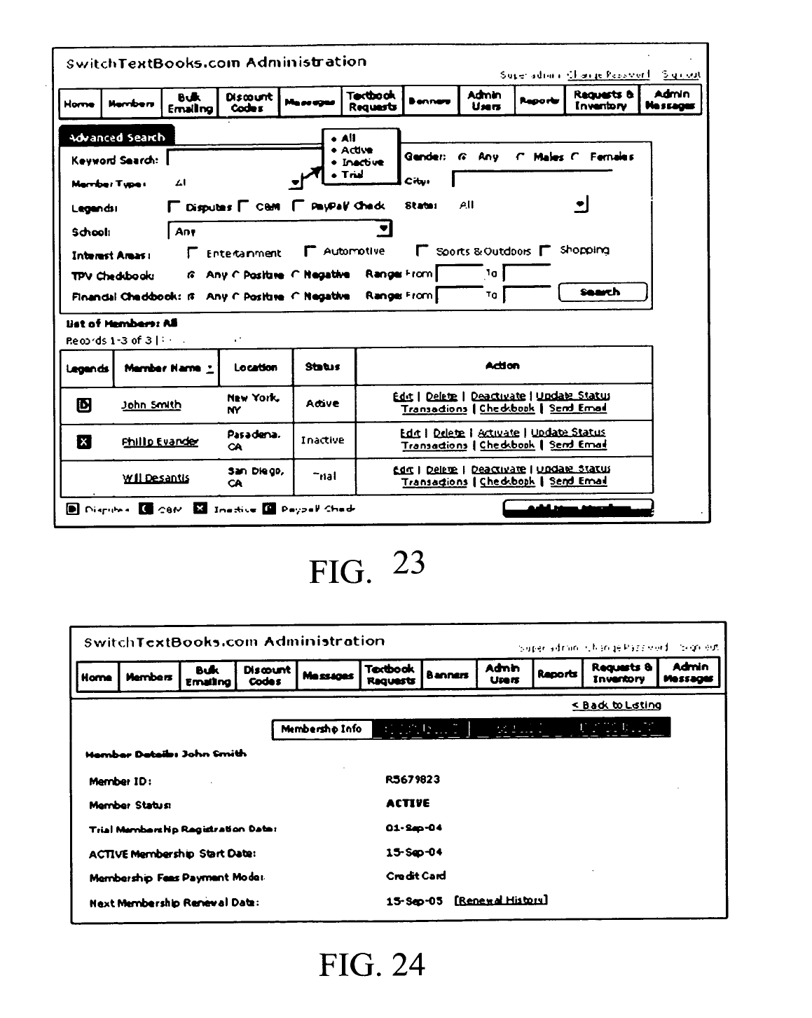

FIG. 23 is a screen print of the ‘Membership Management Utility’ main page. At bottom the ‘Membership Management Utility’ displays a list of the all Registered Members. The Administrator is able to search for specific member records by utilizing the ‘Advanced Search Feature’ at middle, which allows searching on the basis of permutation and combination of various search parameters, including Keyword Search for searching specific member on the basis of first name/last name, Gender Search for any or male or female members, Member Type for all or only active or only inactive or only trial members, City, State, Legends for member records with specific legends (i.e. members with disputed transactions or members who have selected PayPal or Check as membership fees payment mode), School, Areas of Interest, TPV Checkbook (positive or negative TPV points within a specific range), or Financial Checkbook (positive or negative points within a specific range). On selecting the appropriate ‘Search Parameters’ and then clicking on the ‘Search’ button, the system will search for specific records matching the criteria and will display the results below.

Each ‘Member Record’ displayed in the list is accompanied by the following details in multiple columns:
Legends—There are primarily 4 types of legends:
   Disputes—This legend is assigned to a member record and is displayed in the list against that particular record if that member has been involved in minimum 2 disputed transactions. Disputed transactions are those transactions in which the ‘Receiver’ has informed the network while accepting a book from the ‘Owner’ that he/she has received a WRONG Book.
   Members Identified for Transactions—This legend is assigned to a member record and is displayed in the list against that particular record if the application detects that this particular member has sent 2 or more books to respective ‘Receivers’ as a ‘Sender/Owner, however he/she has not received any book in return, as a ‘Receiver’.
   Inactive—This legend is assigned to a member record and is displayed in the list against that particular record if the member has been manually deactivated by the Administrator.
   PayPal/Check—This legend is assigned to a member record and is displayed in the list against that particular record if the member pays the membership fees via ‘Offline Mode’ i.e. PayPal or Check and NOT online Credit Card.
Member Name—This column will display the full name of the member, and the member name is linked to member details. On clicking the member name link the admin is able to view the complete member details as shown in FIG. 24, inclusive of Membership Info, Member ID (8 digit member code), Member Status, Trial Membership Registration Date, Active Membership Start Date, Membership Fees Payment Mode, Next Membership Renewal Date, Personal Details (personal details and areas of interest), Credit Card Details, and Member Rating.
Location—This column will display the location of the member i.e. City+State.
Status—This column will display the status of the member i.e. Active, Inactive or Trial.
Action—This column has various action buttons for the Administrator to take appropriate actions on the member records. The various action links are as follows:
   Edit—The Administrator is able to click on this link to edit a member record.
   Delete—The Administrator can click on this link to delete a member record permanently. On clicking this link, a confirmation message box will pop-up informing the Administrator that the ‘Delete’ action will permanently remove the record and if he wants to proceed. If the administration confirms the action by clicking on the ‘Yes’ button, the record is deleted permanently.
   Activate/Deactivate—Each record has either a ‘Activate’ or a ‘Deactivate’ link. If the member record is ‘ACTIVE’, then a ‘Deactivate’ link is displayed and by clicking this link the Administrator is able to deactivate the active member. If the member record is ‘INACTIVE’, then the action link to be displayed is ‘ACTIVATE’ and by clicking on this link the inactive member record can be once again activated.
   Update Status—The Administrator can click on this link to update the status of the member record. The Administrator will use this action link to update a member status manually from ‘TRIAL’ to ‘ACTIVE’, if the ‘TRIAL’ member has paid the ‘Membership Fees’ via Check or PayPal.
   Transactions—The Administrator can click on this link to view the complete transaction details of the member. The Administrator is able to view the complete list of both ‘Sender’ and ‘Receiver’ related transactions (via the sub-navigation links) for the selected member. The Administrator is ONLY able to view the status of each transaction. The Administrator will NOT be able to ‘Update’ any transaction status i.e. no action links is provided in this ‘Admin section’ for member transactions.
   Checkbook—The Administrator can click on this link to view and adjust the trading as well as financial checkbook details of the member. Each member record in the ‘Member Listing’ page is also associated with a ‘Checkbook’ action link. On clicking this link, the Administrator is taken to the ‘Checkbook’ details page for that user. This Action Button is described in more detail below.
   Send Email—The Administrator is able to directly send email to the member by clicking this action link. On clicking this action link associated with the member record, the Administrator is taken to the ‘Compose Email’ page which is part of the ‘Bulk Email Management Admin Utility’. This Action Button is described in more detail below.

The Checkbook Detail Page (Accessible Via ‘Checkbook’ Action Link)

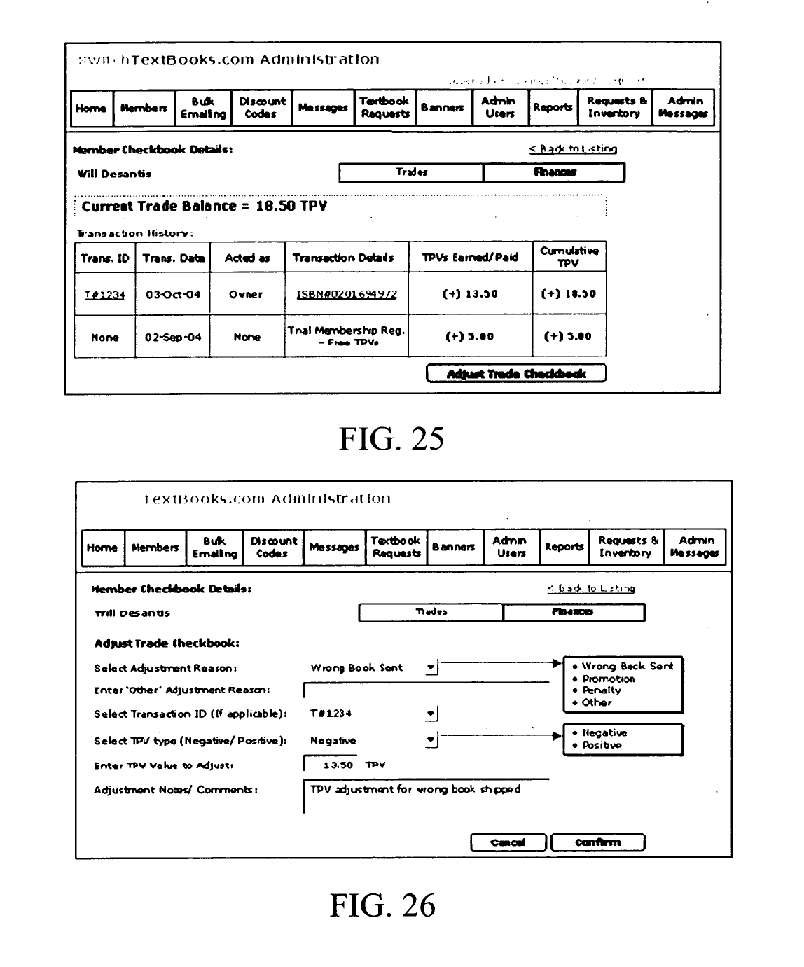

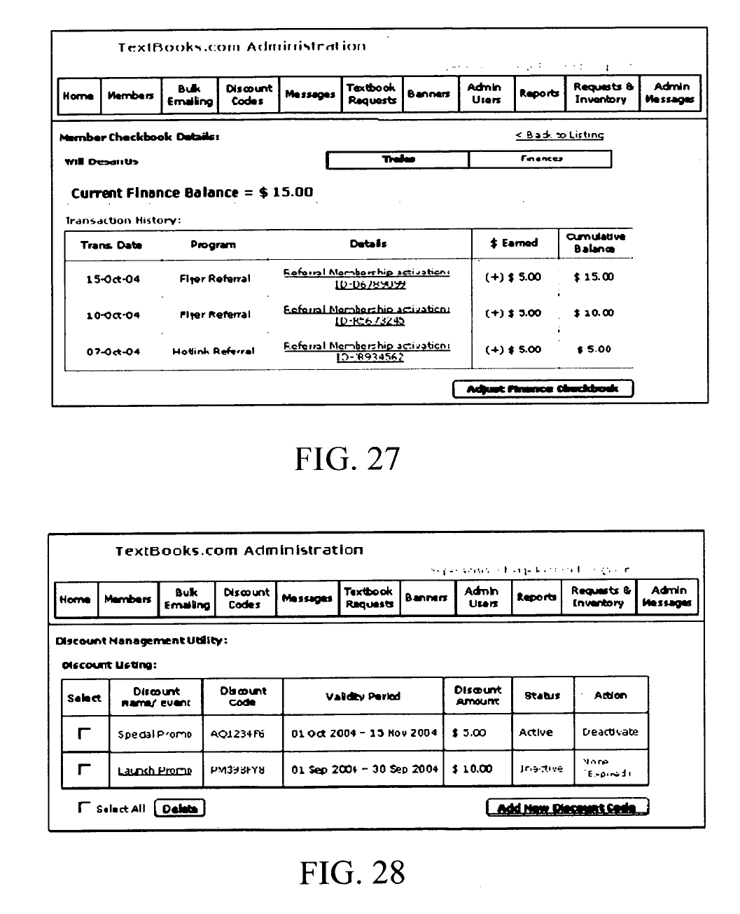

FIG. 25 is a screen shot of the ‘Checkbook’ details page of a member. The Administrator’ is able to view the ‘Trades’ checkbook as well as the ‘Finances’ (Referral bonus etc.) checkbook of the member by clicking on the appropriate sub-navigation links in the above page. The default ‘Member Checkbook’ sub-section is ‘Trade (TPV)’ checkbook. The ‘Trades’ checkbook functionality was previously explained. In this particular sub-section, the Administrator is able to view the same trade checkbook details as the member views via his personal account area from the front-end. However, in this page the Administrator has an additional functionality to balance/adjust the member's checkbook by clicking on the ‘Adjust Trade Checkbook’ button. On clicking the ‘Adjust Trade Checkbook’ button the Administrator is taken to the ‘Adjust Trade Checkbook’ details page as shown in FIG. 26. The Administrator can select the adjustment reason from the drop down list: Wrong Book Sent, Promotion, Penalty, and Other (must then enter the exact reason in a textbox). If the adjustment being done is specific to any particular transaction, then the Administrator is able to select the transaction ID from this dropdown list-box. The drop-down list-box will only show ALL the transaction IDs in which this particular member has taken part either as a sender or a receiver. The Administrator may also select TPV Type (Negative or Positive), Enter TPV Value to Adjust, and Adjustment Notes/Comments. Once, the Administrator confirms the trade adjustment, this particular adjustment record is viewed in the ‘Trade checkbook’ of the member (updated view both in admin and front-end) along with the other trade checkbook transactions as well as the appropriate amount of TPVs is added or subtracted from the member's ‘Trade Checkbook’ based on the negative or positive value selected by the member. The trade checkbook balance is also updated accordingly. The ‘Finances’ checkbook is also accessible, and the Administrator is able to view the same finances checkbook details as the member views it via his personal account area from the front-end. FIG. 27 is a screen print of the ‘Finances Checkbook of a member. The Administrator has an additional functionality to balance/adjust the member's finances checkbook by clicking on the ‘Adjust Finance Checkbook’ button. This takes the Administrator to an ‘Adjust Trade Checkbook’ details page similar to that of the trade adjustment form explained previously (the ‘Adjustment Reasons’ in this form is different from the ‘Trade Adjustment’ as well as the ‘adjustment’ will not be on TPVs but in dollars). Once, the Administrator confirms the finance adjustment, this particular adjustment record is viewed in the ‘Financial checkbook’ of the member (updated view both in admin and front-end) along with the other finance checkbook transactions as well as the appropriate amount of dollars is added or subtracted from the member's ‘Finance Checkbook’ based on the negative or positive value selected by the member. The finance checkbook balance is also updated accordingly.

The Send Email Detail Page (Accessible Via ‘Email’ Action Link)

Referring back to FIG. 23, the Administrator is able to directly send email to the member by clicking this action link. On clicking this action link associated with the member record, the Administrator is taken to the ‘Compose Email’ page which is part of a ‘Bulk Email Management Admin Utility’ This ‘Bulk Email Management Utility’ can be used by the Administrator for sending bulk email messages to all the members of the network or only to selected members. The Administrator clicks on the ‘Bulk Emailing’ link on the top navigation bar to go to the main page of this admin utility. The ‘E-mail Management Admin Utility’ has 2 sub-sections, which is available via the sub-section navigation links:

Send Email

Email Archive

The default sub-section is ‘Send Email’.

The ‘E-mail Management Admin Utility’ main page i.e. the default ‘Send Email’ sub-section page has a ‘Advanced Search’ feature, which will allow the Administrator to search for specific member records based on the advanced search criteria.

Add New Member—The Administrator is also able to add new member records manually via the ‘member listing’ page by clicking on the ‘Add New Member’ button. The Administrator is able to edit the member details by clicking on the ‘EDIT” action link associated with each member record, or change the Member Status amongst Active, Inactive and Trial. This is necessary when ‘Check’ or ‘PayPal’ payments are received, as the Administrator can click on the ‘Update Status’ link in the member listing page to come to this ‘Member Status Update’ details page.

Discount Management Utility

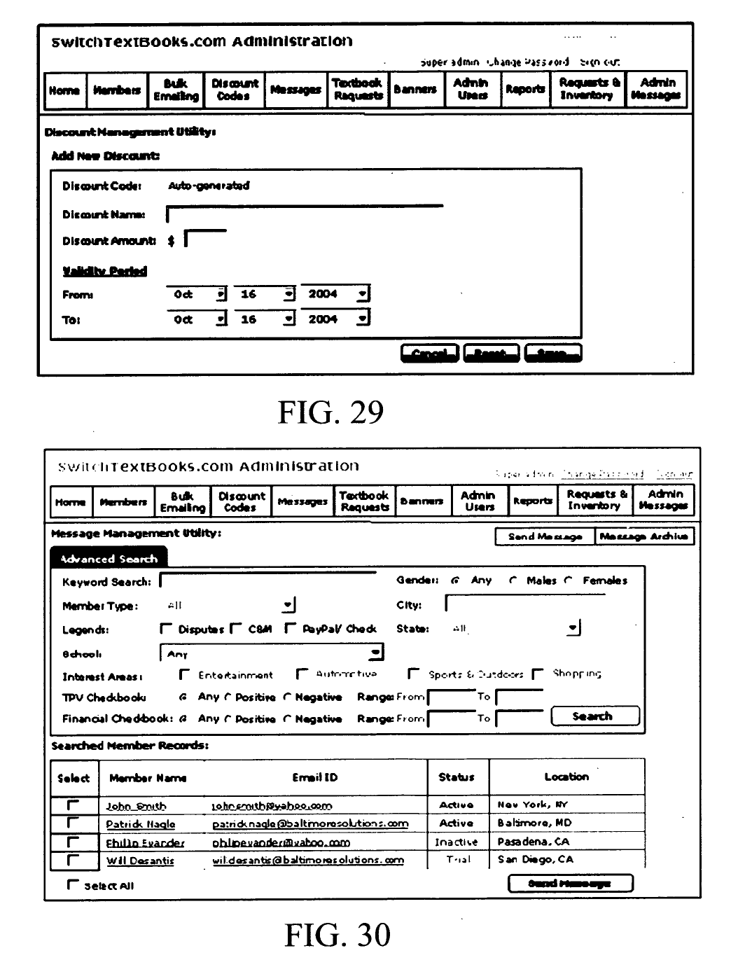

The Administrator is able to generate promotional discount codes via a ‘Discount Management Utility’ accessible through the Discount Codes Link (top navigation bar) of FIG. 23. These discounts are for distribution to students as promotions (these discount codes are separate from the ‘Flyer Program Referral Discount Codes’). These are Alphanumeric 8-digit codes similar to the auto-generated 8-digit member code (which is also used as flyer referral code), but unique so that none of these codes clash. The Administrator clicks on the ‘Discount Codes’ link on the top navigation bar to go to the main page of this admin utility. FIG. 28 is a screen print of the ‘Discount Management Utility’ main page which has a list of all the promotional discounts added by the Administrator, and each is associated with the following details:
Select Checkbox—On selecting the checkbox associated with a record and then clicking on the ‘Delete’ button will delete the selected record.
Discount Name—The discount name or the name of the promotional event is displayed in this column. This ‘Discount label’ is linked. So by clicking on this link the Administrator is able to view the discount details.
Discount Code—This column will display the ‘Discount Code’, which is used by the members while registering via front-end, to get benefit of the appropriate discount amount.
Validity Period—This column will display the ‘Validity Period’ of the ‘Discount Code’ i.e. ‘From’ date to ‘To’ date. If the Administrator adds the discount code on a particular date but the validity start period of that code is on a later date, then the system automatically ‘ACTIVATEs’ that code on the validity start date after detecting the system date. The ‘Discount Code’ is also automatically deactivated by the system on the ‘validity end date’ by using the same functionality as explained above.
Discount Amount—This column will display the discount amount attached to the appropriate promotional code.
Status—This column will display the appropriate status of the discount code i.e. ‘Active’ or ‘Inactive’. A discount code can be ‘Inactive’ in 2 cases: 1 ) the validity period expired; 2) upon manual deactivation by the Administrator if the code is within validity period, by clicking the associated ‘Deactivate’ link in the action column. The Administrator is also able to activate this valid (but inactive) discount code any time (within the validity period) by clicking the associated ‘Activate’ button in the action column.
Action—The action link column will display a ‘Deactivate’ or ‘Activate’ link based on the ‘Code Status’ and the rules described above.
Add New Discount Code—The Administrator is able to add a new ‘Discount Code’ by clicking on the ‘Add New Discount Code’ button in the Discount code-listing page’. FIG. 29 is a screen print of the ‘Add New Discount’ form page. The Administrator can fill-up the form and click on the ‘Save’ button to add the discount code. On submitting the above form the ‘Discount Code’ is automatically generated by the system and is displayed in the discount codes listing page as a new record.

Message Management Utility

A ‘Message Management Utility’ is also provided that is very similar to the ‘Email Management Utility which has been explained earlier. This is accessible through the Messages Link (top navigation bar) of FIG. 23. However, instead of emails sent, as in case of ‘Email Management’, messages can be sent to the members on their ‘My Messages’ section of the ‘Account Area’ by the admin using this ‘Message Management Utility’. The Administrator clicks on the ‘Messages’ link on the top navigation bar to go to the main page of this admin utility, which is shown in FIG. 30. The ‘Message Management Admin Utility’ is very similar to the Email utility, having 2 sub-sections, which are available via the sub-section navigation links: 1) Send Message; 2) Message Archive. The default ‘Send Message’ sub-section has an ‘Advanced Search’ feature, which will allow the Administrator to search for specific member records based on the advanced search criteria. In the ‘Advance Search’ area, the Administrator is able to either search by only keyword or via member status, city and/or state location. On a successful ‘Search’, this page is refreshed and all the member records matching the advanced search parameters is displayed in a list. The listing may run to multiple pages and appropriate page navigation is provided. Each member record in the searched list is associated with a checkbox to select the appropriate member records, to which the mail has to be sent. Once the Administrator has selected the appropriate member records, he can click on the ‘Compose Message’ link at the bottom of this advanced search page to compose a Message to all the targeted members. Once the message is sent successfully, the Administrator is shown a confirmation message. The ‘Message Archive’ page displays a list of all the messages sent by the Administrator. The Administrator is able to select specific messages by selecting associated checkboxes and clicking on the ‘Delete’ button to delete those messages from the archive.

An identical Admin Message Management Utility is also available for communication between the various Administrator (level-1) for sending internal messages to the SA and it is used by the SA for sending internal messages to all the Administrators of the system. The Administrator is able to go to this ‘Admin Messages Management Utility’ by clicking on this link on the top navigation bar. The Admin Message Management Utility likewise has 2 sub-sections available: Messages and Message Archive. Each received message is displayed along with date of the message, the subject of the message and the name of the message sender in 3 columns. The message subject is linked to the message details page. Each message in the list is also associated with a checkbox. The Administrator can select the checkboxes associated with each message for deleting the message or for sending it to archive. The Administrator can also send a new message to the SA by clicking on the ‘Compose Message’ button. Please note that the ‘Administrators’ (level-2) is only able to send messages to the SA, however the SA is able to send messages to all or selected Administrators.

The message archive section will simply display all the messages send and received by the Administrator via this utility. The Administrator/SA is also able to delete messages from the archive.

Requested Textbooks Management Utility

The Administrator is also provided with a ‘Requested Textbooks Management Utility’ accessible by clicking on the ‘Textbook Requests’ link on the top navigation bar of FIG. 23. This admin utility displays a list of all the requests for unavailable books submitted by the front-end members. As previously described, the front-end members submit this type of request when the textbook they searched is NOT found in the Book database available at the server.

Banner Management Utility

The Administrator is able to go to this ‘Banner Management Utility’ by clicking on the ‘Banners’ link on the top navigation bar of FIG. 23. This is an editing/management utility that allows generation of banners for the promotional area on the right hand side of the ‘Member's Account Area’ screen. The banners to be displayed in the member's account area are based on the ‘Areas of Interest’ selected by the member during registration. Thus, the banner advertisements are mapped to specific ‘Areas of Interest’. There can be also general banners, which are not specific to any area of interest. Currently, there can be 3 different categories of banners which are as follows:

National Banners: Not specific to any state or city.

Regional Banners: Specific to a region/state.

Local Banners: Specific to a city.

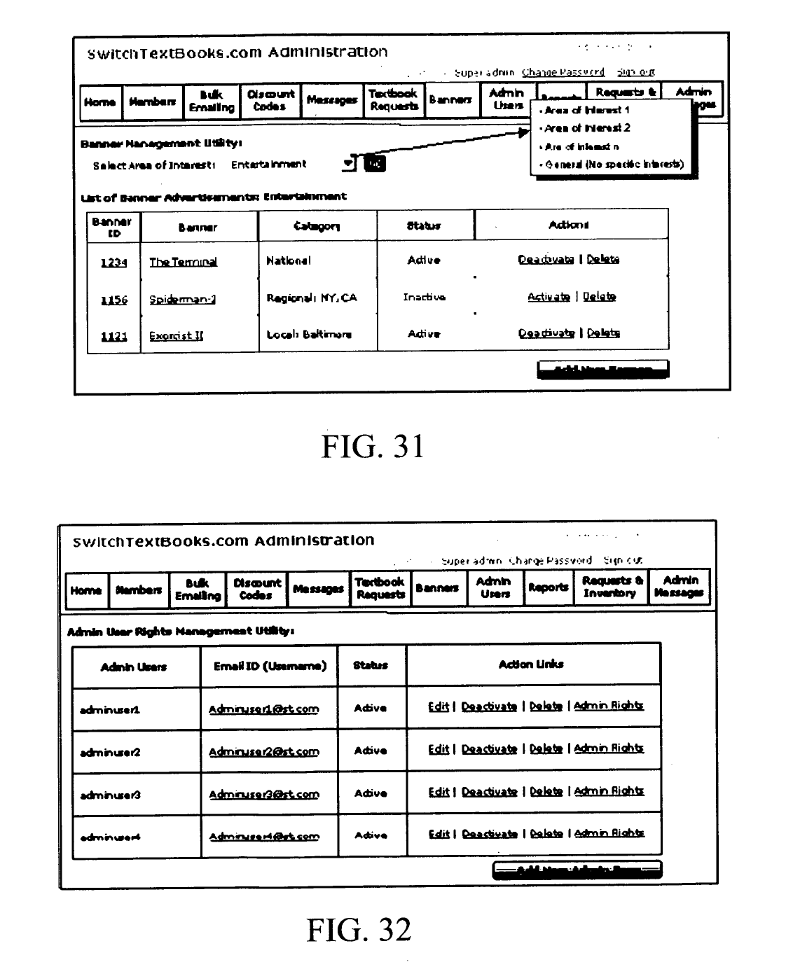

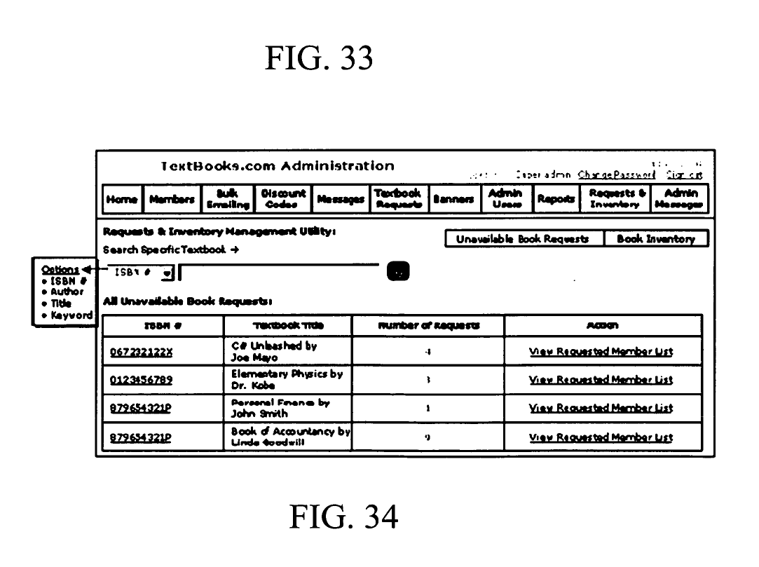

FIG. 31 is a screen print of the ‘Banner Management Utility’ main page. The Administrator has to first select the specific ‘Area of Interest’ from the dropdown list box on the top and click on the associated ‘Go’ button (this list also has a ‘General’ option, which can be selected by the Administrator for listing or adding banner ads, which are NOT specific to any ‘Area of Interest’). On selecting the area of interest and clicking on the ‘Go’ button, the page is refreshed and a list of all the banner advertisements added by the admin for that selected area is displayed below. The banner listing shows the following details:

Banner ID—Unique banner ID identifying each banner ad.

Banner Title—This column displays the banner title, which is linked to the banner details page.

Category—This column displays the banner category, which can be anyone of the following:

National—This type of banners are not specific to any region or city. All members across the country is able to view this type of banner.

Regional—This type of banner can be only viewed by members from specific regions i.e. states. A banner falling in this category can be associated with single or multiple regions (states).

Local—This type of banners can be only viewed by members from specific locations i.e. cities. A banner falling in this category can be associated with single or multiple locations (cities).

Status—A banner can be either ‘Active’ or ‘Inactive’. Inactive banners won't be displayed in the front-end.

Action Links—The action links is as follows:

Activate/Deactivate—If a particular banner is active, then a ‘Deactivate action link is available in this column. If a banner is in inactive state then a ‘Activate’ link is available.

Delete—The Administrator can delete a banner by clicking on this link.

The banner-listing page for a specific ‘Area of Interest’ (or ‘General’) also has a button called ‘Add New Banner’ for adding banners. Administrator can click on this button in the area of interest specific banner listing page to add a new banner for that particular interest area, inclusive of the foregoing banner details plus a banner link to an external URL. After entering the banner URL, the Administrator can click on the ‘Finish’ button to complete the banner addition process.

Administrator Rights Management Utility

Only the ‘Super Administrator’ (SA—single top level Administrator) has access to this specific admin utility. The SA is able to go to this ‘Administrator Rights Management Utility’ by clicking on the ‘Administrators’ link on the top navigation bar of FIG. 23. The SA is able to provide appropriate admin utility rights to the ‘Level-2 Administrators’ via this admin utility. FIG. 32 is a screen print of the ‘Administrator Rights Utility’ main page, which displays a list of all the Administrators added by the SA. The SA is also able to add a new Administrator by clicking on the ‘Add New Administrator’ link. Each admin record in the list is associated with the following details:

Administrator's Full Name

Email ID (This is used by the Administrator as the username to login to the admin module)

Status (Active or Inactive)—If the status of the Administrator in inactive he is blocked from using the admin module.

Action links:

Edit—Edit Administrator's name and e-mail ID

Activate/Deactivate Administrator

Delete—Delete Administrator

Admin Rights—The SA can assign rights to the Administrator by clicking on this link. This engenders a listing of all the foregoing administrative utilities, with a drop down list next to each that allows selection of the assigned administrative rights. The various admin rights available in the list are:
Only View—The Administrator is only able to view the records in each module but won't be able to edit, delete or add any records.
View/Edit
View/Add
View/Delete
View/Edit/Add
View/Edit/Delete
View/Add/Delete
All Rights—This means that the Administrator has all rights for this particular admin utility.
No Rights—This means that the Administrator will not be allowed to access this particular admin utility.

Reporting Management Utility

The Administrator is able to go to this ‘Reporting Management Utility’ by clicking on the ‘Reports’ link on the top navigation bar. This allows the Administrator is able to generate and print various website activity related reports via this admin utility.

Requests and Inventory Management Utility

The Administrator is able to go to this ‘Requests and Inventory Management Utility’ by clicking on this link on the top navigation bar of FIG. 23. However, the Administrator is able to access it only if he has appropriate rights for this admin section. This admin utility has 2 sub-sections, which can be accessed via the sub-navigation links from the admin utility main page. The sub-sections are:

Unavailable book requests by members (the Default)

Book Inventory of members

The Unavailable book requests sub-section displays a list of all the books which have been requested by members in the trading network (i.e. added to their ‘My Requests’ list) however, these books are UNAVAILABLE in the inventory i.e. NOT available with any other member in the network. FIG. 34 is a screenshot of this Unavailable book requests page which displays a list of all the unavailable book requests. This list may run to multiple pages and in that case appropriate page navigation is provided. The list is sorted on a priority basis i.e. the book with maximum requests should be on the top of the ‘Requests’ list as well as the book with the maximum number of copies in the inventory should be on the top of the ‘Inventory’ list. The Administrator is able to even search for specific unavailable book requests by the search function on the top of the page. The unavailable book list is associated with the following details:

ISBN #—ISBN Number of the unavailable book. This number is hyperl inked. Thus by clicking on this link the Administrator is able to view the complete book details which is as follows:

Textbook Title—This column in the listing page will display the title of the unavailable book request.

Number of Requests—This column in the listing page will display the number of requests made by members for this particular unavailable book.

View Requested Member List—This column will a link to the details of all the members who has requested this unavailable book i.e. they have put this book request in their ‘My Requests’ list. On clicking this link, the Administrator is taken to the ‘Members Listing page’ described previously. The Administrator is able to view the member details of any member who requested for this unavailable book by clicking on the member name link.

Available Book Inventory

This sub-section will display a list of all the books, which are AVAILABLE in INVENTORY of other members in the network. The interface is identical to the Unavailable Book Requests (FIG. 34), but allows searching the inventory listing of all members in the network. The results are displayed as ISBN # of the available books along with link to book details page, textbook title, number of books in the inventory for each book and a link to the member listing who possesses the books. On clicking the ‘View Member List with Inventory’ link associated with each book, the Administrator is taken to the member-listing page, which provides details of all the members who possess the book.

It should now be apparent that the above-described ASP framework for peer-to-peer exchanges of used textbooks is of great value to students because is the first efficient platform for exchanging used textbooks, and to facilitate, foster and encourage such transactions while at the same time balancing supply and demand.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

We claim:

1. A web-based peer-to-peer method for providing end users with the ability to exchange textbooks, comprising the steps of:
subscribing a plurality of users and maintaining a trade point account for each subscribed user;
a first user entering a textbook ISBN number of one or more books that they need;
a second user entering information regarding one or more books that they have available for exchange, said information including a textbook ISBN number and condition of each book;
assigning an equivalent trade point value (TPV) to each of said second user's books, said TPV being calculated as a predetermined fraction of an existing retail price of said books factored in accordance with the entered condition of said book, and further factored by a relative supply versus demand for said book;
comparing the ISBN numbers entered by said first and second users and notifying said first user when a match of said ISBN numbers is detected to inform the first user that a requested book is available for exchange;
presenting said first student with a graphical user interface that facilitates an exchange transaction with the second student for the book identified by said matching ISBN numbers;
determining whether the trade point account for said first user reflects a positive trade point balance sufficient to complete said exchange transaction;
binding an agreement between said first and second users when the trade point account for said first user reflects a positive trade point balance sufficient to complete said exchange transaction;
requiring said second user to ship the book identified by said matching ISBN numbers and providing a graphical user interface to enter tracking information;
crediting said second user's account by the TPV of the book identified by said matching ISBN numbers when said second user ships the book; and
debiting said first user's account by the TPV of the book identified by said matching ISBN numbers.

2. The web-base method according to claim 1, wherein said step of subscribing a plurality of users comprises charging an annual subscription fee.

3. A web-based method for providing end users with the ability to exchange textbooks, comprising the steps of:
subscribing a plurality of users and establishing a trade point account for each user;
a first user entering a textbook ISBN number of one or more books that they need;
a second user entering information regarding one or more books that they have available for exchange, said information including a textbook ISBN number and condition of each book;
assigning an equivalent trade point value (TPV) to each of'said second user's books, said TPV being calculated as a predetermined traction of an existing retail price of said books factored in accordance with the entered condition of said book, and further factored by a relative supply versus demand for said book;
comparing the ISBN numbers entered by said first and second users and notifying said first user when a match of said ISBN numbers is detected to inform the first user that a requested book is available for exchange;
facilitating an exchange transaction for the requested book available for exchange by determining whether the trade point account for said first user reflects a positive trade point balance sufficient to complete said exchange transaction and, if so, binding an agreement between said first and second users when the trade point account for said first user reflects a positive trade point balance sufficient to complete said exchange transaction;
debiting the first users trade point account for the assessed TPV of the second user's book.

4. The web-base method according to claim 3, further comprising a step of facilitating shipment of the second user's book to the first user.

5. The web-base method according to claim 4, further comprising a step of crediting the second users trade point account for the assessed TPV of the second user's book upon shipment thereof.

6. The web-base method according to claim 5, further comprising a step of encouraging users to maintain a positive trade point account.
